(19) United States
(12) Patent Application Publication
(10) Pub. No.: US 2025/0196145 A1
(43) Pub. Date: Jun. 19, 2025

(54) DEVICES AND METHODS FOR MITIGATING REACTIVE OXYGEN SPECIES IN A DIGITAL MICROFLUIDIC SYSTEM

(71) Applicant: Nicoya Lifesciences Inc., Kitchener (CA)

(72) Inventors: Harish KRISHNAKUMAR, Cambridge (CA); Chanel LEONG, Sydney (AU)

(21) Appl. No.: 18/988,421

(22) Filed: Dec. 19, 2024

Related U.S. Application Data
(60) Provisional application No. 63/612,149, filed on Dec. 19, 2023.

(51) Int. Cl. B01L 3/00

(52) U.S. Cl. CPC B01L 3/502784; B01L 2200/0673; B01L 2200/16; B01L 2300/0663

(57) ABSTRACT

The present disclosure provides devices and methods for reducing the effects of reactive oxygen species (ROS) in digital microfluidic (DMF) system. ROS may be reduced or entirely prevented through the introduction of ROS scavengers in the droplet operations gap of a DMF system. The mitigation of ROS in a DMF system may reduce or prevent the degradation of reagents, samples, and/or analytes as well as system components such as sensors. Additionally, this disclosure provides devices and methods for detecting and identifying ROS in a DMF system.

### CROSS-REFERENCE

This application claims the benefit of priority to U.S. Provisional Application No. 63/612,149, filed Dec. 19, 2023, which is hereby incorporated by reference in its entirety herein.

### TECHNICAL FIELD

The subject matter relates generally to the detection of molecules, such as DNA, proteins, and the like, and more particularly to devices and methods for mitigating reactive oxygen species (ROS) generated during sample analysis.

### BACKGROUND

Reactive oxygen species (ROS) may be unintentionally generated on a digital microfluidic (DMF) platform in a variety of ways, such as through electrolysis at defect sites and from cartridge components. ROS can degrade and oxidize biological and chemical species (such as halides or sulfides). Therefore, when conducting assays on a DMF platform it is imperative to prevent degradation of reagents and/or samples due to the unwanted generation of ROS. Currently, certain additives and surface modifications exist to improve droplet operations (such as surfactants and pickering emulsions) and prevent loss of analytes from the aqueous phase (due to aqueous to oil phase partitioning). These methods, however, either do not address the issues associated with ROS-induced sample degradation or unfavorably interfere with the assays themselves.

### SUMMARY

In one aspect the present disclosure provides method for reducing reactive oxygen species (“ROS”) in a digital microfluidic (“DMF”) device. In some embodiments, the method includes the steps of: providing a DMF device comprising a top substrate, a bottom substrate, and a gap therebetween for performing droplet operations; forming a droplet within the gap of the DMF device; and contacting the droplet with a ROS scavenger disposed within the gap of the DMF device.

In some embodiments, the ROS scavenger is one or more different ROS scavengers, the ROS scavenger is selected from the group consisting of: superoxide dismutase, catalase, glutathione peroxidase, sodium pyruvate, mannitol, ascorbic acid, glutathione, phenol, polyphenol, thiols, CeO₂, MnO₂, hexyl maltoside, polyglycerol surfactants, alpha-tocopherol, cellulose nanocrystals and other polysaccharide pickering emulsifiers, or combinations thereof. In some embodiments, the ROS scavenger is selected from superoxide dismutase, sodium pyruvate, mannitol, CeO2, MnO2, hexyl maltoside, alpha-tocopherol or combinations thereof.

In some embodiments, the ROS scavenger is disposed on at least a portion of a surface of the DMF device. In some embodiments, contacting the droplet with the ROS scavenger comprises contacting the droplet with the portion of the surface of the DMF device having the ROS scavenger disposed thereon. In some embodiments, the surface is a sensor surface. In some embodiments, the sensor surface is a surface plasmon resonance (SPR) or localized surface plasmon resonance (LSPR) sensor surface. In some embodiments, the SPR or LSPR sensor surface comprises a metal selected from the group consisting of: Gold, Silver, Copper, or combinations thereof. In some embodiments, the surface is a surface of the top or bottom substrate. In some embodiments, the surface is a surface of one or more beads. In some embodiments, the one or more beads are one or more magnetic beads.

In some embodiments, the ROS scavenger is disposed within a filler fluid. In some embodiments, contacting the droplet with the ROS scavenger comprises contacting the droplet with the filler fluid such that the ROS scavenger diffuses to an interface between the droplet and the filler fluid. In some embodiments, the ROS scavenger is a surfactant. In some embodiments, the filler fluid is an oil. In some embodiments, the oil is a silicone oil, perfluorinated oil, hydrocarbon-based oil or a combination thereof.

In some embodiments, the ROS scavenger is disposed within a second droplet. In some embodiments, contacting the droplet with the ROS scavenger comprises merging the droplet with the second droplet.

In some embodiments, the fluid droplet comprises one or more of a reagent, sample, or analyte.

In some embodiments, the ROS scavenger prevents degradation of one or more of the reagent, sample, or analyte.

In another aspect, the present disclosure provides a method for reducing reactive oxygen species (“ROS”) in a digital microfluidic (“DMF”) device. In some embodiments, the method includes the steps of: providing a DMF device comprising a top substrate, a bottom substrate, and a gap therebetween for performing droplet operations; forming a droplet within the gap of the DMF device wherein the droplet comprises a ROS scavenger.

In some embodiments, the ROS scavenger is one or more different ROS scavengers. In some embodiments, the ROS scavenger is selected from the group consisting of: superoxide dismutase, catalase, glutathione peroxidase, sodium pyruvate, mannitol, ascorbic acid, glutathione, phenol, polyphenol, thiols, CeO2, MnO2, hexyl maltoside, polyglycerol surfactants, alpha-tocopherol, cellulose nanocrystals and other polysaccharide pickering emulsifiers, or combinations thereof. In some embodiments, the ROS scavenger is selected from superoxide dismutase, sodium pyruvate, mannitol, CeO2, MnO2, hexyl maltoside, alpha-tocopherol or combinations thereof.

In some embodiments, the ROS scavenger is a surfactant.

In some embodiments, the fluid droplet comprises one or more of a reagent, sample, or analyte. In some embodiments, the ROS scavenger prevents degradation of one or more of the reagent, sample, or analyte.

In another aspect, the present disclosure provides a method for detecting reactive oxygen species (“ROS”) in a digital microfluidic (“DMF”) device. In some embodiments, the method includes the steps of: providing a DMF device comprising a top substrate, a bottom substrate, and a gap therebetween for performing droplet operations; forming a droplet within the gap of the DMF device; contacting the droplet with one or more plasmonic nanoparticles; and measuring a change in the plasmon resonance of the one or more nanoparticles, wherein the change in the plasmon resonance of the one or more nanoparticles is due to degradation of the one or more nanoparticles in the presence of ROS.

In some embodiments, the degradation comprises etching. In some embodiments, the degradation comprises decoupling of the one or more nanoparticles from a surface of the DMF device.

In some embodiments, the one or more nanoparticles comprise a high aspect ratio. In some embodiments, the high aspect ratio facilitates degradation of the one or more nanoparticles in the presence of ROS.

In some embodiments, the one or more nanoparticles comprises a ligand. In some embodiments, the ligand is selected from the group consisting of: hexadecyltrimethylammonium bromide (CTAB), hexadecyltrimethylammonium chloride (CTAC), cysteine, and combinations thereof. In some embodiments, the ligand facilitates degradation of the one or more nanoparticles in the presence of ROS.

In some embodiments, the method further includes contacting the one or more nanoparticles with a halide. In some embodiments, contacting the one or more nanoparticles with a halide facilitates degradation of the one or more nanoparticles in the presence of ROS.

In some embodiments, the one or more nanoparticles comprises a metal selected from the group consisting of: Gold, Silver, Copper, or combinations thereof.

In some embodiments, the one or more nanoparticles are disposed on a surface of the DMF device. In some embodiments, the surface is a sensor surface. In some embodiments, the surface is LSPR sensor surface.

In some embodiments, the method further includes the step of: determining a concentration of ROS in the droplet, wherein the concentration of ROS in the droplet corresponds to the change in the plasmon resonance of the one or more nanoparticles.

In some embodiments, the method further includes the steps of: providing a ROS scavenger to the gap of the DMF device; contacting the droplet with the ROS scavenger within the gap of the DMF device; and determining the identity of ROS using the ROS scavenger, wherein the identity of the ROS corresponds to a type of ROS scavenger.

In some embodiments, the ROS scavenger is selected from the group consisting of: superoxide dismutase, catalase, glutathione peroxidase, sodium pyruvate, mannitol, ascorbic acid, glutathione, phenol, polyphenol, thiols, CeO2, MnO2, hexyl maltoside, polyglycerol surfactants, alpha-tocopherol, cellulose nanocrystals and other polysaccharide pickering emulsifiers, or combinations thereof. In some embodiments, the ROS scavenger is selected from superoxide dismutase, sodium pyruvate, mannitol, CeO2, MnO2, hexyl maltoside, alpha-tocopherol or combinations thereof.

In some embodiments, the ROS scavenger reduces the change in the plasmon resonance of the one or more nanoparticles.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 illustrates a block diagram of an example of a digital microfluidic (DMF) system including ROS scavengers for mitigating reactive oxygen species in a DMF device (or cartridge), in accordance with an embodiment of the disclosure;

FIG. 2A and FIG. 2B illustrate schematic diagrams of an example of an LSPR sensor for analysis of analytes in the DMF device of the DMF system;

FIG. 3 illustrates a side view of an example of an LSPR sensor for analysis of analytes in the DMF device of the DMF system;

FIG. 4 illustrates a schematic diagram of an example of a gold particle and the generation of ROS at a defect site;

FIG. 5A, FIG. 5B, FIG. 6A, and FIG. 6B illustrate cross-sectional views of a portion of a DMF device and including ROS scavengers on surfaces within the droplet operations gap and coming into contact with aqueous droplets;

FIG. 7A and FIG. 7B illustrate cross-sectional views of a portion of a DMF device and including ROS scavengers in the oil phase within the droplet operations gap and coming into contact with aqueous droplets;

FIG. 8A and FIG. 8B illustrates cross-sectional views of a portion of a DMF device and including magnetic beads functionalized with ROS scavengers;

FIG. 9 illustrates a flow diagram of an example of a method of reducing ROS in a DMF device by providing ROS scavengers within the DMF device itself, in accordance with an embodiment of the disclosure;

FIG. 10A through FIG. 12 illustrate cross-sectional views of a portion of a DMF device and examples of including ROS scavengers within the aqueous droplet for protecting biological and/or chemical reagents and/or samples therein;

FIG. 13 illustrates a flow diagram of an example of a method of reducing ROS in a DMF device by providing ROS scavengers within aqueous droplets therein, in accordance with an embodiment of the disclosure;

FIG. 14 and FIG. 15 illustrate schematic diagrams of examples of mechanisms for the detection of ROS using colloidal plasmonic nanoparticles;

FIG. 16 illustrates a schematic diagram of an example of detecting ROS using plasmonic nanoparticles immobilized on an optical fiber;

FIG. 17A, FIG. 17B, FIG. 17C illustrate a process of detecting ROS using plasmonic nanoparticles attached to an optical fiber by an adhesive that is responsive to H₂O₂;

FIG. 18 illustrates a schematic diagram of an example of a method to determine whether ROS is generated through the introduction of target analyte and/or to determine whether the ROS scavenger is effective at inhibiting oxidation by ROS;

FIG. 19 is a schematic diagram of an example of a method to determine whether analyte triggers generation of hydroxyl radicals or hydrogen peroxide;

FIG. 20 illustrates a flow diagram of an example of a method of detecting ROS in a DMF device, in accordance with an embodiment of the disclosure;

FIG. 21 illustrates an example of a plot showing the change in gold nanourchins LSPR peak over time in varying concentrations of H₂O₂ and sodium pyruvate;

FIG. 22, FIG. 23, and FIG. 24 illustrate examples of plots showing the change in gold nanourchins LSPR peak over time in varying concentrations of H₂O₂, sodium bromide, and sodium pyruvate, respectively;

FIG. 25 and FIG. 26 show a photo and a plot, respectively, of an example of the detection of unwanted generation of ROS on a DMF device using plasmonic nanoparticles; and

FIG. 27 through FIG. 30 show plots of examples of the change in hue value of gold nanourchins +NaBr mixtures with sodium pyruvate addition.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

In some embodiments, the subject matter provides devices and methods for mitigating reactive oxygen species (ROS) in a digital microfluidic device.

In some embodiments, the devices and methods for mitigating ROS provide a DMF system including a DMF device (or cartridge), a controller, a DMF interface, a detection system, one or more magnets, and one or more thermal control mechanisms and wherein the DMF device (or cartridge) may further include one or more electrode arrangements.

In some embodiments, the devices and methods for mitigating ROS on a DMF device (or cartridge) may include one or more electrode arrangements and wherein each of the electrode arrangements may include, but is not limited to, any arrangements (e.g., lines, paths, arrays) of droplet operations electrodes (i.e., electrowetting electrodes), one or more reservoirs, one or more localized surface plasmon resonance (LSPR) sensors, and one or more types of ROS scavengers for mitigating ROS in the DMF device (or cartridge).

In some embodiments, the devices and methods for mitigating ROS provide methods of using ROS scavengers to protect biological and chemical reagents and/or samples on a DMF platform.

In some embodiments, the devices and methods for mitigating ROS provide methods of using ROS scavengers for reducing or entirely preventing ROS in a DMF device (or cartridge) and thereby reducing or entirely preventing the degradation of reagents, samples, and/or analyte due to the unwanted generation of ROS.

In some embodiments, the devices and methods for mitigating ROS provide methods of reducing or entirely preventing ROS in a DMF device (or cartridge) by providing ROS scavengers on surfaces within the droplet operations gap of the DMF device (or cartridge).

In some embodiments, the devices and methods for mitigating ROS provide methods of reducing or entirely preventing ROS in a DMF device (or cartridge) by providing ROS scavengers within the aqueous droplets themselves.

In some embodiments, the devices and methods for mitigating ROS provide methods of detecting ROS in a DMF device (or cartridge).

### Terms and Definitions

“Core-shell particles” means particles that consist of a core particle encapsulated by a shell. The shell may comprise one, two, three, four, or more layers.

“Filler fluid” means oil that is added to a DMF device or cartridge that forms the continuous phase surrounding aqueous droplets. Filler fluid may be a low-viscosity oil, such as silicone oil or hexadecane filler fluid. The filler fluid may contain additives such as surfactants.

“Free radical” means any molecular species that has an unpaired electron and is thus highly unstable and reactive. By either contributing or accepting an electron, free radicals can behave as reductants or oxidants, respectively. Free radicals are produced by a variety of normal biological processes including aerobic metabolism and pathogenic defense mechanisms. They can also be a result of external exposures such as radiation, pollutants, and cigarette smoke.

“Localized surface plasmon resonance (LSPR)” means the collective oscillation of electrons at the interface of metallic nanostructures induced by light excitation.

“Nanoparticles” means particles or structures with one or more dimensions less than 100 nm.

“Plasmonic nanoparticles” means nanoparticles whose electron density can couple with electromagnetic radiation of wavelengths larger than the particle. Plasmonic nanoparticles exhibit intense light absorbance, scattering, and/or extinction properties. Plasmonic nanoparticles typically consist of at least one layer or component of noble metals (e.g., gold, silver, palladium, platinum, etc.).

“Reactive oxygen species (ROS)” means molecules capable of independent existence, containing at least one oxygen atom and one or more unpaired electrons. ROS are a subset of free radicals that contain oxygen. A few of the most common reactive oxygen species include hydroxyl radical, superoxide anion, and hydrogen peroxide (H₂O₂).

“Reactive oxygen species (ROS) scavenger” broadly means any chemical or biological molecule that is capable of detoxifying one or more ROS subspecies by different mechanisms defined by the chemistry of the ROS scavenger and the ROS subspecies. Therefore, a ROS scavenger not only scavenges radicals (e.g., ·OH and O₂·—) but can also scavenge nonradicals (e.g., H₂O₂) or more than one ROS subspecies in dependency of the chemical structure of the scavenger.

### DMF System Including ROS Scavengers

ROS may be unintentionally generated on a DMF platform in a variety of ways, and this poses a risk to biological and chemical reagents/samples, as they may be oxidized and degraded. Herein, several methods are proposed to protect chemical and biological species from degradation by ROS when conducting DMF-based assays. These methods may also reduce degradation of system components such as, for example, sensors, due to unwanted ROS generation. Additionally, methods are proposed to detect undesired generation of ROS on DMF by using plasmonic nanoparticles, thereby effectively serving as an on-cartridge quality control test. Lastly, novel plasmonic nanoparticle-based assays on DMF are proposed to detect and characterize ROS generation by biological and chemical analytes. These designs have potential for use in new drug screening (e.g., to determine whether a new drug candidate has toxic side effects such as generating high concentrations of ROS) and cell studies (e.g., evaluating the role of ROS in cancer development).

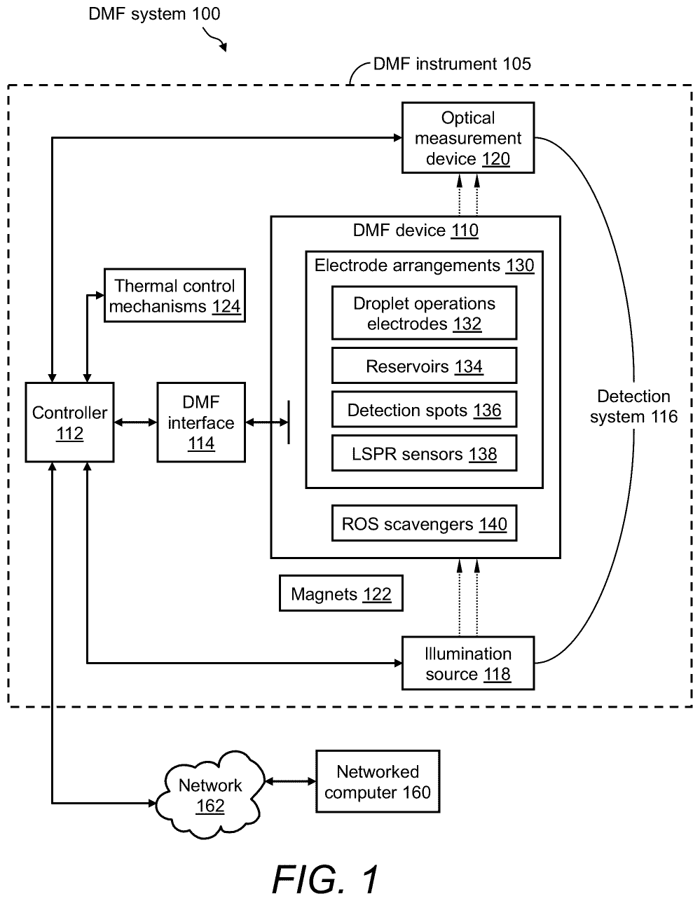

Referring now to FIG. 1 is a block diagram of an example of a DMF system 100 including ROS scavengers for mitigating reactive oxygen species in a DMF device (or cartridge), in accordance with an embodiment of the disclosure. Accordingly, DMF system 100 provides ROS scavengers in a DMF device for protecting biological and chemical reagents and/or samples being processed on a DMF platform. That is, DMF system 100 supports a DMF platform that uses ROS scavengers for reducing or entirely preventing degradation of reagents, samples, and/or analyte due to the unwanted generation of ROS.

In this example, DMF system 100 may include a DMF instrument 105. Further, DMF instrument 105 may house a DMF device (or cartridge) 110 along with any supporting components. DMF device 110 of DMF system 100 may be, for example, any fluidics device or cartridge, microfluidic device or cartridge, digital microfluidic (DMF) device or cartridge, droplet actuator, flow cell device or cartridge, and the like. In various embodiments, DMF system 100 provides DMF device 110 that may support automated processes to manipulate, process, and/or analyze biological materials.

DMF device 110 may be provided, for example, as a disposable and/or reusable device or cartridge. DMF device 110 may be used for processing biological materials. Generally, DMF device 110 may facilitate DMF capabilities for fluidic actuation including droplet transporting, merging, mixing, splitting, dispensing, diluting, agitating, deforming (shaping), and other types of droplet operations. Applications of these DMF capabilities may include, for example, sample preparation and waste removal. In one example, the DMF capabilities of DMF device 110 of DMF system 100 may be used to perform assays, such as, but not limited to, PCR protocols. For example, the DMF capabilities of DMF device 110 and DMF system 100 may be used for processing a patient sample and performing an assay. In DMF system 100, DMF device 110 may be provided, for example, as a disposable and/or reusable cartridge.

DMF system 100 may further include a controller 112, a DMF interface 114, a detection system 116, one or more magnets 122, and one or more thermal control mechanisms 124. Controller 112 may be electrically coupled to the various hardware components of DMF system 100, such as to DMF device 110, detection system 116, magnets 122, and thermal control mechanisms 124. In particular, controller 112 may be electrically coupled to DMF device 110 via DMF interface 114, wherein DMF interface 114 may be, for example, a pluggable interface for connecting mechanically and electrically to DMF device 110.

Detection system 116 may be any detection mechanism that can be used to accurately determine the presence or absence of a defined analyte and/or target component in different materials and to sensitively quantify the amount of analyte and/or target components present in a sample. Detection system 116 may be, for example, an optical measurement system that includes an illumination source 118 and an optical measurement device 120. For example, detection system 116 may be a fluorimeter that provides both excitation and detection.

The illumination source 118 may be, for example, a light source for the visible range (400-800 nm), such as, but not limited to, a white light-emitting diode (LED), a halogen bulb, an arc lamp, an incandescent lamp, lasers, and the like. Illumination source 118 is not limited to a white light source. Illumination source 118 may be any color light that is useful in DMF system 100. Optical measurement device 120 may be used to obtain light intensity readings. Optical measurement device 120 may be, for example, a charge coupled device, a photodetector, a spectrometer, a photodiode array, or any combinations thereof. Further, DMF system 100 is not limited to one detection system 116 only (e.g., one illumination source 118 and one optical measurement device 120 only). DMF system 100 may include multiple detection systems 116 (e.g., multiple illumination sources 118 and/or multiple optical measurement devices 120) to support multiple detection spots 136.

Controller 112 may, for example, be a general-purpose computer, special purpose computer, personal computer, microprocessor, or other programmable data processing apparatus. Controller 112 may provide processing capabilities, such as storing, interpreting, and/or executing software instructions, as well as controlling the overall operations of DMF system 100. The software instructions may comprise machine readable code stored in non-transitory memory that is accessible by the controller 112 for the execution of the instructions. Controller 112 may be configured and programmed to control data and/or power aspects of DMF system 100. Further, data storage (not shown) may be built into or provided separate from controller 112.

Thermal control mechanisms 124 may be any mechanisms for controlling the operating temperature of DMF cartridge 110. Examples of thermal control mechanisms 124 may include Peltier elements and resistive heaters.

Generally, controller 112 may be used to manage any functions of DMF system 100. For example, controller 112 may be used to manage the operations of, detection system 116 (e.g., illumination source 118 and optical measurement device 120), magnets 122, thermal control mechanisms 124, and any other instrumentation (not shown) in relation to DMF device 110. Magnets 122 may be, for example, permanent magnets and/or electromagnets. In the case of electromagnets, controller 112 may be used to control the electromagnets 122. Further, with respect to DMF device 110, controller 112 may control droplet manipulation by activating/deactivating electrodes.

In other configurations of DMF system 100, the functions of controller 112, detection system 116 (e.g., illumination source 118 and optical measurement device 120), magnets 122, thermal control mechanisms 124, and/or any other instrumentation may be integrated directly into DMF device 110 rather than provided separately from DMF device 110.

Optionally, DMF instrument 105 may be connected to a network. For example, controller 112 may be in communication with a networked computer 160 via a network 162. Networked computer 160 may be, for example, any centralized server or cloud-based server. Network 162 may be, for example, a local area network (LAN), a wide area network (WAN), or a cellular network for connecting to the internet.

Further, DMF device 110 of DMF system 100 may include one or more electrode arrangements 130. Each of the electrode arrangements 130 may include, but is not limited to, any arrangements (e.g., lines, paths, arrays) of droplet operations electrodes 132 (i.e., electrowetting electrodes). Droplet operations electrodes 132 may be used to fluidly connect any arrangements of one or more reservoirs 134. Further, certain droplet operations electrodes 132 may be designated as detection spots 136. In one example, illumination source 118 and optical measurement device 120 may be arranged with respect to detection spots 136 of DMF device 110.

Reservoirs 134 may be any fluid sources integrated with or otherwise fluidly coupled to DMF device 110. Reservoirs 134 may include any number and/or arrangements of, for example, on-cartridge reservoirs, off-cartridge reservoirs, blister packs, fluid ports, and the like, and any combinations thereof. Reservoirs 134 may be used to manage any liquids, such as reagents, buffers, sample volumes, and the like, needed to support any processes of DMF device 110. On-cartridge reservoirs 134, for example, may be formed of particular arrangements of droplet operations electrodes 132.

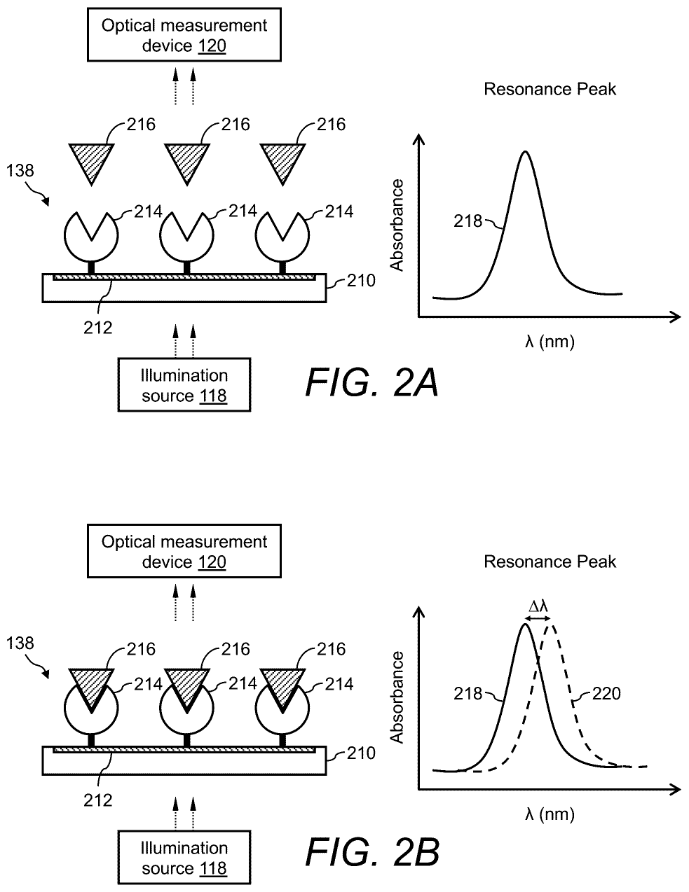

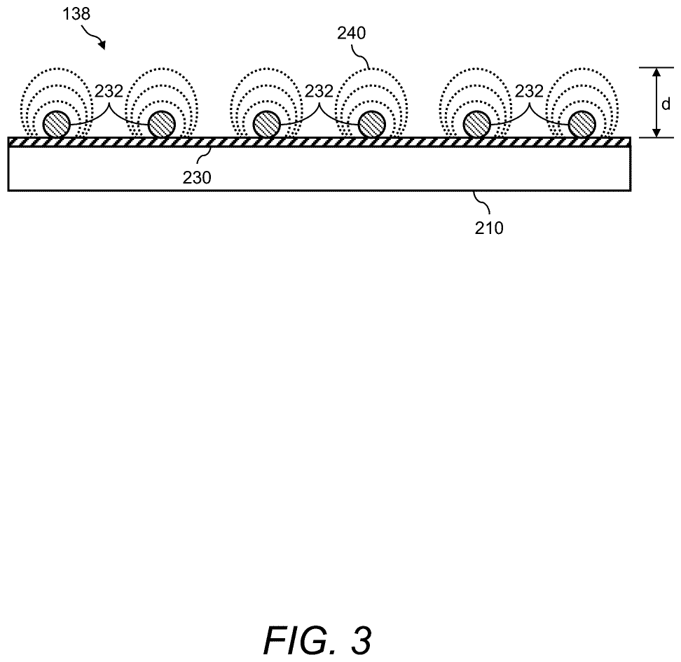

Further, each of the electrode arrangements 130 may include one or more localized surface plasmon resonance (LSPR) sensors 138. Generally, LSPR sensors (e.g., LSPR sensors 138) may be functionalized for (1) detecting, for example, certain molecules (e.g., target analytes) and/or chemicals in the sample, and (2) analysis of analytes; namely, for measuring binding events in real time to extract ON-rate information, OFF-rate information, and/or affinity information. More details of examples of LSPR sensors are shown and described hereinbelow with reference to FIG. 2A, FIG. 2B, and FIG. 3.

Additionally, ROS scavengers 140 may be provided within DMF device 110 for mitigating the unwanted effects of ROS on LSPR sensors 138. Accordingly, ROS scavengers 140 are provided for protecting biological and chemical reagents and/or samples being processed in DMF device 110. That is, ROS scavengers 140 may be used for reducing or entirely preventing degradation of reagents, samples, and/or analyte due to the unwanted generation of ROS.

Again, ROS means molecules capable of independent existence, containing at least one oxygen atom and one or more unpaired electrons. This group includes oxygen free radicals (e.g., superoxide anion radical, hydroxyl radical, hydroperoxyl radical, singlet oxygen) as well as free nitrogen radicals. ROS are generated when oxygen is supplied in excess, electrolysis occurs and/or its reduction is insufficient.

ROS scavengers 140 may be any chemical or biological molecule that is capable of detoxifying one or more ROS subspecies by different mechanisms defined by the chemistry of the ROS scavengers 140 and the ROS subspecies. Therefore, ROS scavengers 140 not only scavenge radicals (e.g., ·OH and O₂·—) but can also scavenge nonradicals (e.g., H₂O₂) or more than one ROS subspecies in dependency of the chemical structure of the scavenger.

In DMF device 110, the degradation due to ROS may manifest itself by, for example, the etching of the plasmonic nanoparticles (e.g., gold nanoparticles) of the LSPR sensors 138 (see FIG. 2A, FIG. 2B, FIG. 3). Etching of plasmonic nanoparticles changes the shape of the particles which shifts the LSPR peak of the nanoparticles. More specifically, etching of the nanoparticles results in changes in the light absorbance, scattering, extinction and/or fluorescence quenching properties of the nanoparticles that can be detected with the naked eye and/or with instrumentation (e.g., a smartphone camera, which is one example of optical measurement device 120). Accordingly, ROS scavengers 140 are provided in DMF device 110 to mitigate the unwanted effects of ROS.

In DMF device 110, ROS scavengers 140 may be one or more different scavengers. For example, ROS scavengers 140 are selected from superoxide dismutase, catalase, glutathione peroxidase, sodium pyruvate, mannitol, ascorbic acid, glutathione, phenol, polyphenol, thiols, CeO₂, MnO₂, hexyl maltoside, polyglycerol surfactants, alpha-tocopherol, cellulose nanocrystals and other polysaccharide pickering emulsifiers, or combinations thereof. Further, ROS scavengers 140 may be selected from superoxide dismutase, sodium pyruvate, mannitol, CeO₂, MnO₂, hexyl maltoside, alpha-tocopherol or combinations thereof.

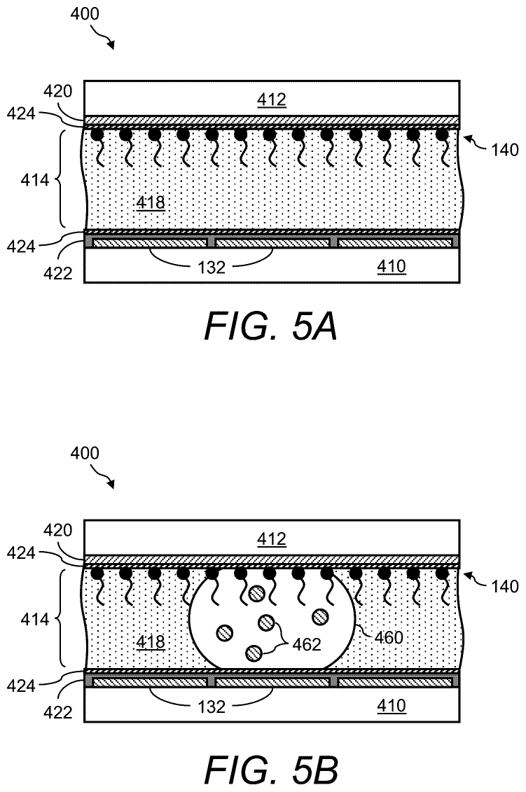

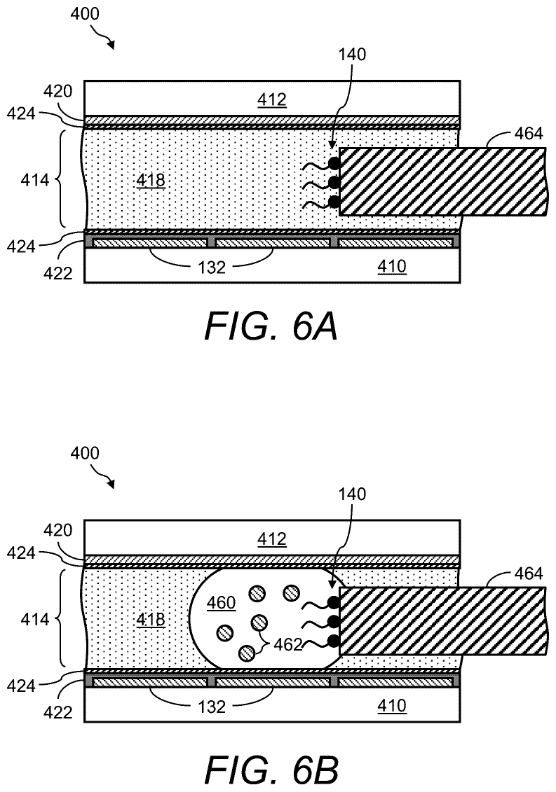

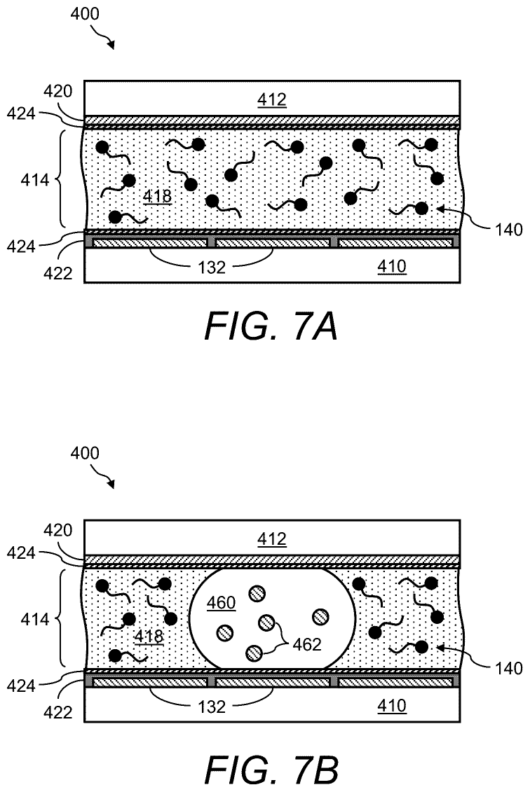

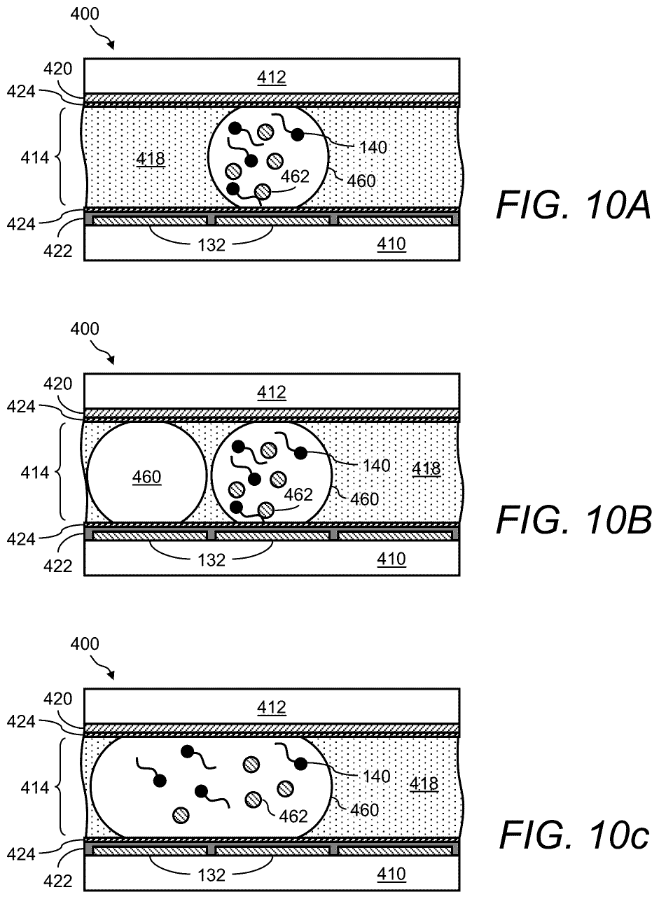

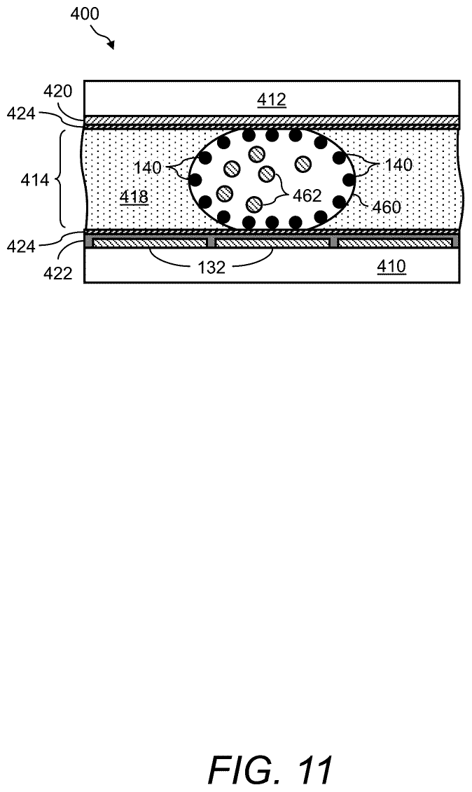

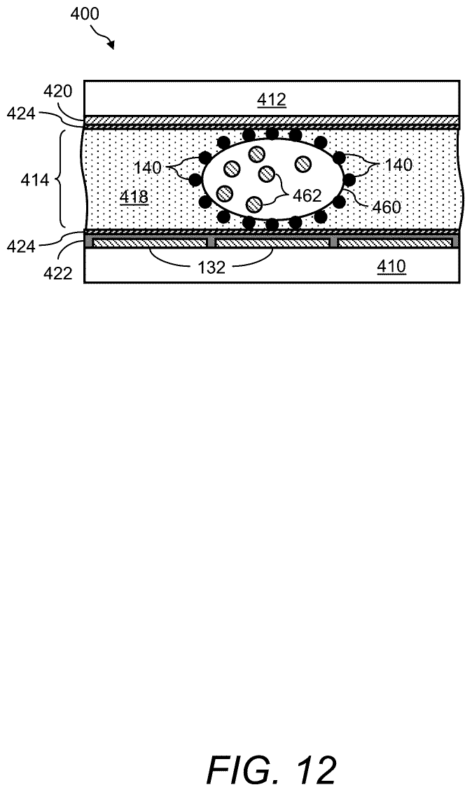

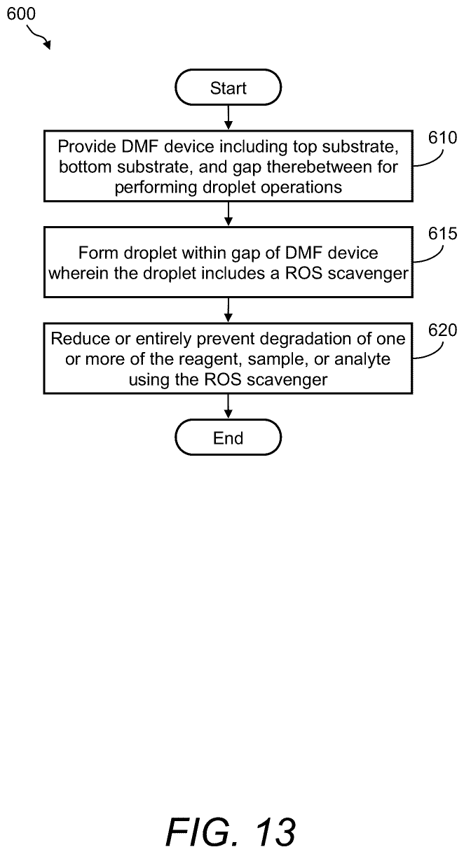

In one example, ROS scavengers 140 may be provided on surfaces within the droplet operations gap of DMF device 110 and coming into contact with aqueous droplets therein (see FIG. 5A, FIG. 5B, FIG. 6A, FIG. 6B). In another example, ROS scavengers 140 may be provided in the oil phase within the droplet operations gap of DMF device 110 and coming into contact with aqueous droplets therein (see FIG. 7A, FIG. 7B). In yet another example, ROS scavengers 140 may be provided in or on the aqueous droplets themselves within DMF device 110 (see FIG. 10, FIG. 11, FIG. 12, FIG. 13).

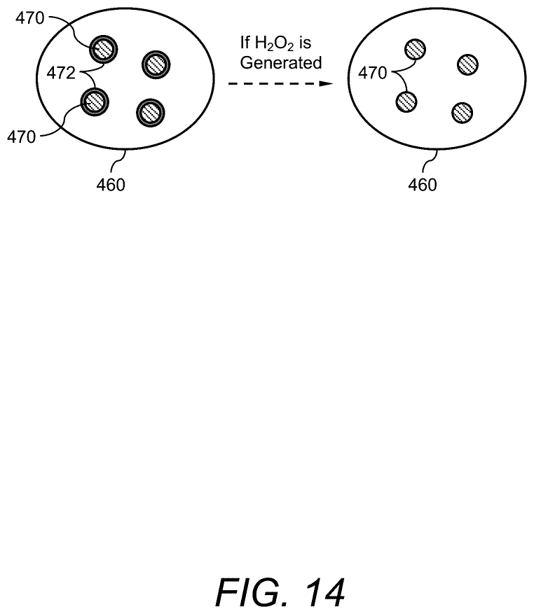

Further, ROS scavengers 140 within DMF device 110 of DMF system 100 may be used for detecting the presence of ROS within the biological and chemical reagents and/or samples being processed in DMF device 110. More details of using ROS scavengers 140 for ROS detection are described below in FIG. 14 through FIG. 30.

Referring now to FIG. 2A and FIG. 2B are schematic diagrams of an example of an LSPR sensor 138 for analysis of analytes in DMF device 110 of DMF system 100. Generally, LSPR is label-free interaction analysis in real-time. However, LSPR can also be used with labels to enhance the signal. The basic structure of the assay is a sensor chip (e.g., LSPR sensor 138) that includes a glass or plastic substrate with a surface that produces LSPR, such as a collection of discrete nanostructures distributed on a surface, or a continuous film that has nano-sized features formed therein, as shown, for example, in FIG. 3. Then, one of two binding partners is immobilized on the surface of the sensor. In LSPR, the “ligand” is the binding partner that is immobilized on the surface of the sensor. The “analyte” is what flows in solution over the ligand on the surface of the sensor. When the analyte binds to the ligand, it changes the optical properties of the surface of the sensor, which is measurable in real time.

In one example, LSPR sensor 138 may include a substantially transparent or opaque substrate 210, such as a glass, coated glass, quartz, plastic, or TPE substrate. Namely, substrate 210 may be substantially transparent when LSPR sensor 138 is used in a transmission mode configuration. In another example, substrate 210 may be opaque when LSPR sensor 138 is used in a reflection mode configuration. An LSPR sensor layer 212 is provided atop substrate 210. LSPR sensor layer 212 can be, for example, a gold film that includes certain nanostructures (see FIG. 3) that create an LSPR effect. LSPR sensor layer 212 is functionalized with one or more capture molecules 214. In one example, capture molecules 214 are ligands that are immobilized on the surface of LSPR sensor layer 212. In this example, the ligands are one of two binding partners, the other binding partner being a target analyte 216, wherein the target analyte 216 flows in solution over the capture molecules 214 as shown in FIG. 2A. By contrast, FIG. 2B shows the target analytes 216 binding to capture molecules 214. This binding may be referred to as a binding event.

Referring now again to FIG. 2A, a plot 218 is provided that indicates the optical absorbance peak of LSPR sensor layer 212 prior to a binding event occurring. That is, plot 218 shows the peak position or intensity prior to target analytes 216 binding to capture molecules 214 in LSPR sensor 138. Referring now to FIG. 2B, the change in peak position or intensity that is induced by binding of the target analytes 216 to the capture molecules 214 can be monitored in real time. For example, by comparing the peak position prior to binding (i.e., plot 218) with the peak position after binding (i.e., plot 220). Generally, in LSPR sensor 138, as analytes bind to the surface, the resonance peak of the light will shift to a higher wavelength, which is measurable in real time.

Referring now to FIG. 3 is an example of a LSPR sensor 138 wherein the LSPR sensor layer includes nanostructures that can produce an LSPR signal. For example, FIG. 3 shows a side view of an LSPR sensor 138 that includes colloidal-shaped nanostructures. Namely, LSPR sensor 138 includes the substantially transparent substrate 210, such as a glass, plastic, or TPE substrate. Next, an adhesive layer 230 is provided atop substrate 210. Next, an array or arrangement of nanoparticles 232 are provided on the surface of adhesive layer 230. In one example, nanoparticles 232 can be metal nanoparticles (e.g., gold, silver, copper nanoparticles, or combinations thereof) that are immobilized on or linked to substrate 210 using physical or chemical coupling, such as using adhesive layer 230. Nanoparticles 232 can be, for example, from about 1 nm to about 1000 nm in various dimensions and in various shapes, such a spheres, stars, rice, cubes, cages, urchins, rods, and the like. Next, capture molecules 214 (not shown) as described in FIG. 2A and FIG. 2B can be immobilized on nanoparticles 232. In this example, the LSPR sensor 138 emits an electric field 240 that is present very close to the surface. In one example, electric field 240 covers distance d of from about 0 nm to about 100 nm from the surface. Additionally, other examples of LSPR sensor 138 are shown below in FIG. 14 through FIG. 19.

### Methods of Using ROS Scavengers to Protect Biological and Chemical Reagent/Samples on DMF

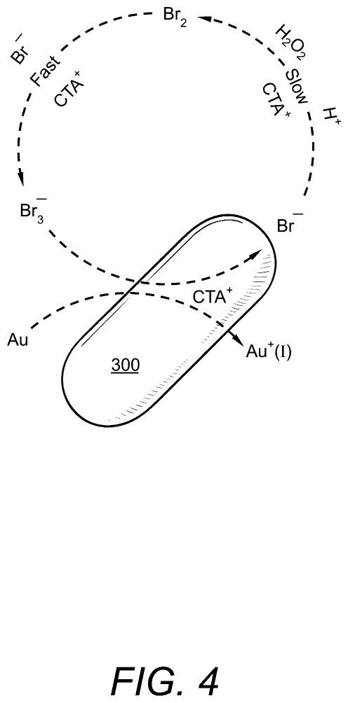

Referring now to FIG. 4 is a schematic diagram of an example of a gold nanoparticle (or nanourchin) 300 and the generation of ROS at a defect site. In this example, ROS, such as H₂O₂, are generated at defect sites of the DMF device. This triggers the oxidation of bromide, which then catalyzes etching/oxidation of gold nanourchins. ROS generation may be due to electrolysis or another mechanism.

FIG. 4 shows an example of pathways of ROS-catalyzed generation of reactive bromine species as follows:
Hydrogen Peroxide: H₂O₂+2H⁺+3Br⁻→Br₃⁻+2H₂O
Hydroxyl Radical: OH+Br⁻→BrOH⁻
BrOH⁻+Br⁻→Br₂⁻+OH⁻

Referring now to FIG. 5A, FIG. 5B, FIG. 6A, and FIG. 6B are cross-sectional views of a portion of DMF device 110 and including ROS scavengers 140 on surfaces within the droplet operations gap and coming into contact with aqueous droplets. The ROS scavengers 140 are provided to protect biological and/or chemical reagents and/or samples in DMF device 110. For example, FIG. 5A, FIG. 5B, FIG. 6A, and FIG. 6B show a DMF structure 400. The formation of DMF device 110 of DMF system 100 may be based generally on DMF structure 400.

DMF structure 400 may be used to form any arrangements (e.g., lines, paths, arrays) of droplet operations electrodes 132 (i.e., electrowetting electrodes). DMF structure 400 may include a bottom substrate 410 and a top substrate 412 separated by a droplet operations gap 414. Droplet operations gap 414 may contain filler fluid 418, such as silicone oil or hexadecane. Bottom substrate 410 may be, for example, a silicon substrate or a printed circuit board (PCB). Bottom substrate 410 may include an arrangement of droplet operations electrodes 132 (e.g., electrowetting electrodes). Droplet operations electrodes 132 may be formed, for example, of copper, gold, or aluminum.

A dielectric layer 422 (e.g., parylene coating, silicon nitride) may be atop droplet operations electrodes 132. Top substrate 412 may be, for example, a glass or plastic substrate. Top substrate 412 may include a ground reference electrode 420. In one example, ground reference electrode 420 may be formed of indium tin oxide (ITO) and wherein ITO is substantially transparent to light. Further, a hydrophobic layer 424 may be provided on both the side of bottom substrate 410 and the side of top substrate 412 that is facing droplet operations gap 414. Examples of hydrophobic materials or coatings may include, but are not limited to, polytetrafluoroethylene (PTFE), Cytop, Teflon™ AF (amorphous fluoropolymer) resins, FluoroPel™ coatings, silane, and the like.

Droplet operations may be conducted atop droplet operations electrodes 132 on a droplet operations surface. For example, droplet operations may be conducted atop droplet operations electrodes 132. That is, an aqueous droplet 460 may be present in droplet operations gap 414 of DMF structure 400. In one example, droplet 460 may be a droplet of a blood sample (or fraction thereof) or a saliva sample to be evaluated. In another example, droplet 460 may be a reagent droplet for conducting an assay. In yet another example, droplet 460 may be a reaction droplet that may or may not include a target analyte of interest. Filler fluid 418 may fill droplet operations gap 414 and surround droplet 460.

With respect to providing ROS scavengers 140 on surfaces within droplet operations gap 414 of DMF structure 400, ROS scavengers 140 may be coated on bottom substrate 410, on top substrate 412, or on both bottom substrate 410 and top substrate 412 of DMF structure 400. In one example, FIG. 5A and FIG. 5B show ROS scavengers 140 coated on the surface of top substrate 412 facing droplet operations gap 414, at, for example, a certain portion or region of top substrate 412. FIG. 5A shows droplet operations gap 414 absent droplet 460. By contrast, FIG. 5B shows a droplet 460 present within droplet operations gap 414. Here, droplet 460 is generally an aqueous droplet in oil phase (e.g., filler fluid 418).

Further, some amount of reagent 462 or analyte 462 or sample 462 may be present within droplet 460. In this example, the droplet 460 containing reagent 462 or analyte 462 or sample 462 is in contact with ROS scavengers 140 on top substrate 412. In this way, ROS scavengers 140 may be used to reduce or entirely prevent the degradation of reagents, samples, and/or analyte in droplet 460 due to the unwanted generation of ROS. More specifically, ROS scavengers 140 are used to detoxify one or more ROS subspecies by different mechanisms defined by the chemistry of the ROS scavengers 140 and the ROS subspecies.

Further, any surfaces within droplet operations gap 414 coated with ROS scavengers 140 may include LSPR sensors 138. In the example shown in FIG. 5A and FIG. 5B, some portion of top substrate 412 that is coated with ROS scavengers 140 may include one or more LSPR sensors 138.

In another example, FIG. 6A and FIG. 6B show a substrate or structure 464 protruding into droplet operations gap 414 of DMF structure 400. In one example, substrate or structure 464 may be an optical fiber. In this example, ROS scavengers 140 may be coated on at least one surface of substrate or structure 464. Further, in the example shown in FIG. 6A and FIG. 6B, the tip of substrate or structure 464 (e.g., an optical fiber) that is coated with ROS scavengers 140 may be an LSPR sensor 138.

FIG. 6A shows droplet operations gap 414 absent droplet 460. By contrast, FIG. 6B shows a droplet 460 present within droplet operations gap 414. Again, some amount of reagent 462 or analyte 462 or sample 462 may be present within droplet 460. In this example, the droplet 460 containing reagent 462 or analyte 462 or sample 462 is in contact with metallic nanoparticles 140 on substrate or structure 464. That is, substrate or structure 464 coated with metallic nanoparticles 140 may protrude into the aqueous droplet 460. The metallic nanoparticles 140 may be etched by ROS species present in droplet 460 thus serving as an indicator of ROS generation. Etching of the metallic nanoparticles on substrate or structure (fiber optic) can be measured by a spectrometer in reflectance mode.

Referring now to FIG. 7A and FIG. 7B are cross-sectional views of DMF structure 400 including ROS scavengers 140 in the oil phase (e.g., filler fluid 418) within droplet operations gap 414 and coming into contact with aqueous droplets. Again, the ROS scavengers 140 are provided for protecting biological and/or chemical reagents and/or samples in DMF device 110.

In this example, ROS scavengers 140 are mixed in filler fluid 418 and have poor solubility in aqueous phase. Accordingly, ROS scavengers 140 are provided to mitigate the presence of ROS within filler fluid 418 and/or droplet 460.

Further, in the examples shown in FIG. 7A and FIG. 7B, contacting droplet 460 with ROS scavengers 140 means the ROS scavengers 140 diffuse to an interface between the aqueous droplet 460 and filler fluid 418.

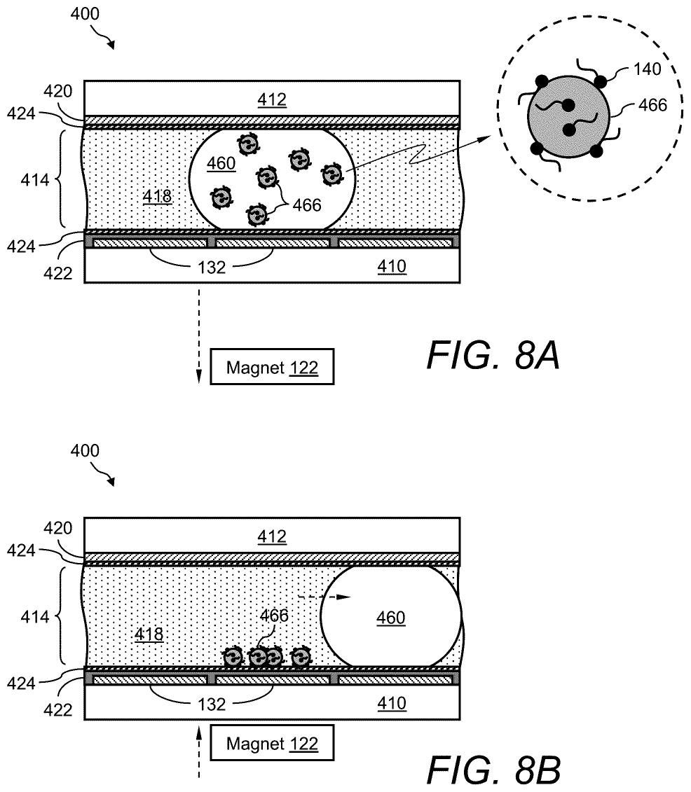

Magnetic nanoparticles encapsulated in a porous bead (e.g. alginate bead) may be imbibed with ROS scavengers which are slowly released into the droplet. Alternatively, ROS species may diffuse into the ROS scavenger-imbibed porous matrix as a detoxification method. Magnetic nanoparticles may then be removed from the droplet by application of a magnetic field. For example and referring now to FIG. 8A and FIG. 8B are cross-sectional views of DMF structure 400 including magnetic beads 466 functionalized with ROS scavengers 140. That is, FIG. 8A shows magnetic beads 466 with the ROS scavengers 140 and suspended in droplet 460. Further, FIG. 8B shows magnetic beads 466 with the ROS scavengers 140 immobilized within droplet operations gap 414 using, for example, magnet 122. In this example, magnetic beads 466 may be held immobilized while sample droplets are moved over the magnetic beads 466 with the ROS scavengers 140. In this way, the magnetic beads 466 facilitate the presence of ROS scavengers 140 within droplet operations gap 414. Further, in this example, the immobilized magnetic beads 466 with the ROS scavengers 140 may be released into solution at any time.

In another example, instead of magnetic beads 466, charged (or electrically responsive) beads 466 may be provided and used in a similar fashion. That is, charged beads 466 with ROS scavengers 140 may be immobilized using an electric field.

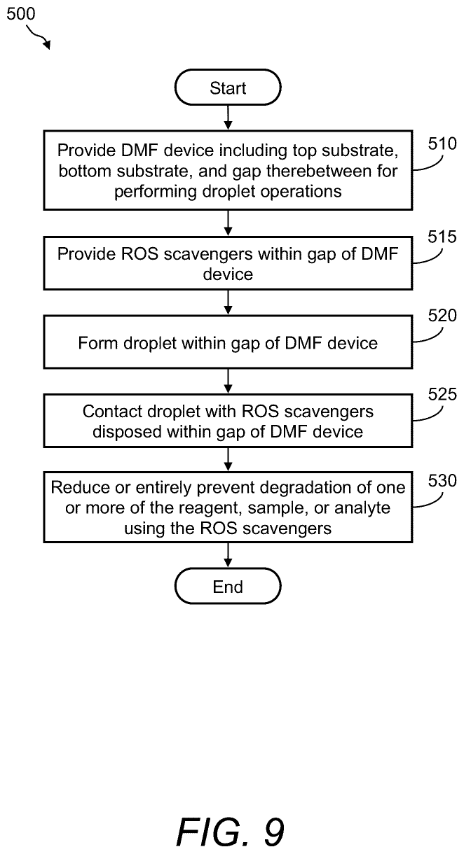

Referring now to FIG. 9 is a flow diagram of an example of a method 500 of reducing ROS in a DMF device by providing ROS scavengers within the DMF device itself, in accordance with an embodiment of the disclosure. For example, method 500 may be used to reduce or entirely prevent ROS in DMF device 110 by providing ROS scavengers 140 within the DMF device 110 itself. Method 500 may include, but is not limited to, the following steps.

At step 510, a DMF device is provided including a top substrate, a bottom substrate, and a droplet operations gap therebetween for performing droplet operations. For example, DMF device 110 shown in FIG. 1 may be provided and wherein DMF device 110 may be formed according to DMF structure 400 shown and described in FIG. 5A and FIG. 5B. That is, DMF structure 400 including top substrate 412, bottom substrate 410, and droplet operations gap 414 therebetween for performing droplet operations.

At step 515, ROS scavengers are provided within the droplet operations gap of the DMF device. ROS scavengers 140 may be one or more different scavengers. For example, ROS scavengers 140 may be selected from superoxide dismutase, catalase, glutathione peroxidase, sodium pyruvate, mannitol, ascorbic acid, glutathione, phenol, polyphenol, thiols, CeO₂, MnO₂, hexyl maltoside, polyglycerol surfactants, alpha-tocopherol, cellulose nanocrystals and other polysaccharide pickering emulsifiers, or combinations thereof. Further, ROS scavengers 140 may be selected from superoxide dismutase, sodium pyruvate, mannitol, CeO₂, MnO₂, hexyl maltoside, alpha-tocopherol or combinations thereof.

In one example, ROS scavengers 140 may be coated on bottom substrate 410, on top substrate 412, or on both bottom substrate 410 and top substrate 412 of DMF structure 400. By way of example, FIG. 5A shows ROS scavengers 140 coated on the surface of top substrate 412 facing droplet operations gap 414. In another example, FIG. 6A shows ROS scavengers 140 coated on at least one surface of substrate or structure 464 protruding into droplet operations gap 414 of DMF structure 400. In yet another example, FIG. 7A shows ROS scavengers 140 mixed in filler fluid 418 within droplet operations gap 414 of DMF structure 400.

Further, in step 515, any surfaces within droplet operations gap 414 coated with ROS scavengers 140 may include LSPR sensors 138. In the example shown in FIG. 5A and FIG. 5B, some portion of top substrate 412 coated with ROS scavengers 140 may include one or more LSPR sensors 138. In the example shown in FIG. 6A and FIG. 6B, substrate or structure 464 may be an optical fiber and wherein the tip of the optical fiber may be an LSPR sensor 138 coated with ROS scavengers 140.

At step 520, a droplet is formed within the droplet operations gap of the DMF device. In one example, FIG. 5B shows droplet 460 containing reagent 462 or analyte 462 or sample 462 is provided in droplet operations gap 414 of DMF structure 400. In another example, FIG. 6B shows droplet 460 in droplet operations gap 414 of DMF structure 400. In yet another example, FIG. 7B shows droplet 460 in droplet operations gap 414 of DMF structure 400.

At step 525, the droplet is contacted with the ROS scavengers disposed within the droplet operations gap of the DMF device. In one example, FIG. 5B shows the droplet 460 containing reagent 462 or analyte 462 or sample 462 in contact with the ROS scavengers 140 on top substrate 412 of DMF structure 400. In another example, FIG. 5B shows droplet 460 containing reagent 462 or analyte 462 or sample 462 in contact with the ROS scavengers 140 on substrate or structure 464 that is protruding into droplet operations gap 414 of DMF structure 400. In yet another example, FIG. 7B shows droplet 460 containing reagent 462 or analyte 462 or sample 462 in contact with the ROS scavengers 140 that are mixed in the filler fluid 418 within droplet operations gap 414 of DMF structure 400.

At step 530, degradation of one or more of the reagent, sample, or analyte within the droplet is reduced or entirely prevented using the ROS scavengers. In one example, degradation of one or more of the reagent, sample, or analyte within the droplet may be reduced or entirely prevented using the ROS scavengers. In one example, degradation of one or more of the reagent 462 or analyte 462 or sample 462 within droplet 460 may be reduced or entirely prevented using the ROS scavengers 140 on top substrate 412 of DMF structure 400, as shown in FIG. 5B. In another example, degradation of one or more of the reagent 462 or analyte 462 or sample 462 within droplet 460 may be reduced or entirely prevented using the ROS scavengers 140 on substrate or structure 464 of DMF structure 400, as shown in FIG. 6B. In yet another example, degradation of one or more of the reagent 462 or analyte 462 or sample 462 within droplet 460 may be reduced or entirely prevented using the ROS scavengers 140 mixed in the filler fluid 418 of DMF structure 400, as shown in FIG. 7B.

Referring now to FIG. 10A through FIG. 12 are cross-sectional views of DMF structure 400 and including ROS scavengers 140 within the aqueous droplet for protecting biological and/or chemical reagents and/or samples therein. Again, the ROS scavengers 140 are provided for protecting biological and/or chemical reagents and/or samples in DMF device 110.

For example, FIG. 10A shows that ROS scavengers 140 may be added directly into the volume of the aqueous droplet 460 to reduce or entirely prevent degradation of one or more of the reagent 462 or analyte 462 or sample 462 therein. FIG. 10B and FIG. 10C show that an aqueous droplet 460 with ROS scavengers 140 may be merged with another aqueous droplet 460 (without ROS scavengers 140) to form a merged droplet 460 with ROS scavengers 140 therein.

Further, ROS scavengers 140 may also function as the surfactant for stabilizing aqueous droplet 460 in filler fluid 418, as shown, for example, in FIG. 11. Here, ROS scavengers 140 may be provided on the inner edge or surface of aqueous droplet 460 and at the interface between the aqueous droplet 460 and filler fluid 418.

Further, ROS scavengers 140 may be colloidal particles that also function as for stabilizing aqueous droplet 460 in filler fluid 418, as shown, for example, in FIG. 12. Here, ROS scavengers 140 may be provided on the outer edge or surface of aqueous droplet 460 and at the interface between the aqueous droplet 460 and filler fluid 418. In one example, ROS scavengers 140 may be used to form a pickering emulsion. Pickering emulsions are systems composed of two immiscible fluids stabilized by organic or inorganic solid particles (e.g., micro- or nano-particles).

Referring now to FIG. 13 is a flow diagram of an example of a method 600 of reducing ROS in a DMF device by providing ROS scavengers within aqueous droplets therein, in accordance with an embodiment of the disclosure. For example, method 600 may be used to reduce or entirely prevent ROS in DMF device 110 by providing ROS scavengers 140 within the aqueous droplets 460 themselves. Method 600 may include, but is not limited to, the following steps.

At step 610, a DMF device is provided including a top substrate, a bottom substrate, and a droplet operations gap therebetween for performing droplet operations. For example, DMF device 110 shown in FIG. 1 may be provided and wherein DMF device 110 may be formed according to DMF structure 400 shown and described in FIG. 5A and FIG. 5B. That is, DMF structure 400 including top substrate 412, bottom substrate 410, and droplet operations gap 414 therebetween for performing droplet operations.

At step 615, a droplet is formed within the droplet operations gap of the DMF device and wherein the droplet includes a ROS scavenger (e.g., ROS scavengers 140). ROS scavengers 140 may be one or more different scavengers. For example, ROS scavengers 140 may be selected from superoxide dismutase, catalase, glutathione peroxidase, sodium pyruvate, mannitol, ascorbic acid, glutathione, phenol, polyphenol, thiols, CeO₂, MnO₂, hexyl maltoside, polyglycerol surfactants, alpha-tocopherol, cellulose nanocrystals and other polysaccharide pickering emulsifiers, or combinations thereof. Further, ROS scavengers 140 may be selected from superoxide dismutase, sodium pyruvate, mannitol, CeO₂, MnO₂, hexyl maltoside, alpha-tocopherol or combinations thereof.

In one example, FIG. 10 shows ROS scavengers 140 added directly into the volume of the aqueous droplet 460. In another example, FIG. 11 shows ROS scavengers 140 may be provided around the inside of aqueous droplet 460 and at the interface between the aqueous droplet 460 and filler fluid 418. Here, ROS scavengers 140 may function as the surfactant for stabilizing aqueous droplet 460 in filler fluid 418. In yet another example, FIG. 12 shows ROS scavengers 140 may be provided around the outside of aqueous droplet 460 and at the interface between the aqueous droplet 460 and filler fluid 418. Here again, ROS scavengers 140 may function as the surfactant for stabilizing aqueous droplet 460 in filler fluid 418.

At step 620, degradation of one or more of the reagent, sample, or analyte within the droplet is reduced or entirely prevented using the ROS scavengers. In one example, degradation of one or more of the reagent, sample, or analyte within the droplet may be reduced or entirely prevented using the ROS scavengers. In one example, degradation of one or more of the reagent 462 or analyte 462 or sample 462 within droplet 460 may be reduced or entirely prevented by adding ROS scavengers 140 directly into the volume of the aqueous droplet 460, as shown in FIG. 10. In another example, degradation of one or more of the reagent 462 or analyte 462 or sample 462 within droplet 460 may be reduced or entirely prevented by providing ROS scavengers 140 around the inside of aqueous droplet 460 and at the interface between the aqueous droplet 460 and filler fluid 418, as shown in FIG. 11. In yet another example, degradation of one or more of the reagent 462 or analyte 462 or sample 462 within droplet 460 may be reduced or entirely prevented by providing ROS scavengers 140 around the outside of aqueous droplet 460 and at the interface between the aqueous droplet 460 and filler fluid 418, as shown in FIG. 12.

### Methods of Monitoring Unwanted Generation of ROS on DMF

The use of colloidal plasmonic nanoparticles to detect ROS generation on DMF is disclosed herein. If ROS is generated, plasmonic nanoparticles may be etched, resulting in a shift in LSPR peak position. The LSPR peak position may be monitored by using an optical fiber coupled to a spectrophotometer. Alternatively, if the shift in LSPR peak also results in a change in nanoparticle color (e.g., change in hue), the nanoparticle color may be monitored through the use of camera-based detection. In practice, these colloidal suspensions may be droplets of plasmonic nanoparticles positioned at one or more locations on the DMF device. These droplets of plasmonic nanoparticles may then be monitored throughout the course of a DMF experiment.

As ROS generation likely varies region to region on a DMF device, a separate droplet containing the ROS scavenger may follow along the same pathway as the sample of interest. This serves as an indicator of ROS in the sample while avoiding undesired interactions between the ROS scavenger and the sample. Examples of mechanisms for detecting ROS in a DMF device, such as DMF device 110 of DMF system 100 shown in FIG. 1, are shown below in FIG. 14 through FIG. 17C.

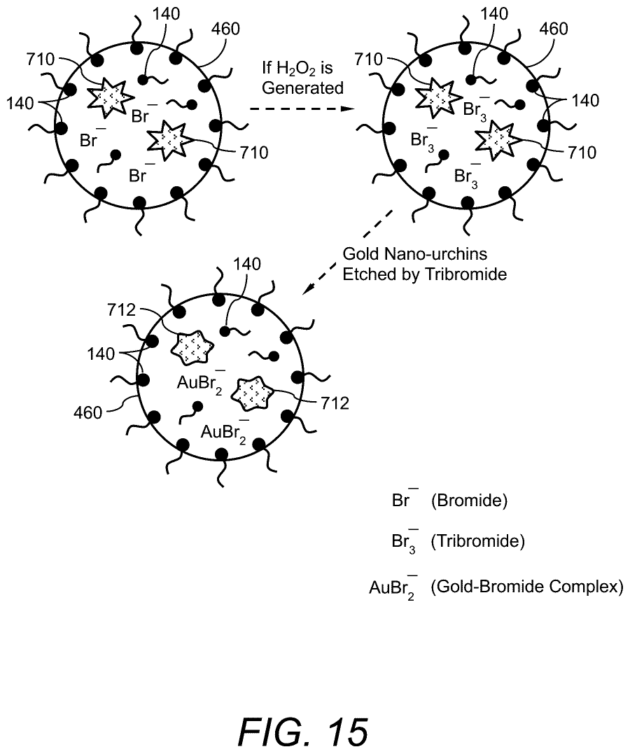

Referring now to FIG. 14 and FIG. 15 are schematic diagrams of examples of mechanisms for the detection of ROS using colloidal plasmonic nanoparticles. For example, FIG. 14 shows an example of detecting ROS using colloidal plasmonic nanoparticles. In this example, droplet 460 may include some quantity of silver-coated gold nanoparticles. For example, droplet 460 may include some quantity of gold nanoparticles 470 having silver coatings 472. Then, if H₂O₂ is generated within droplet 460, the silver coatings 472 may be etched away from the gold nanoparticles 470. Leaving behind the uncoated gold nanoparticles 470 only within droplet 460. In this example, silver coating 472 may be considered a sacrificial layer.

Further, FIG. 15 shows a droplet 460 containing ROS scavengers 140, some quantity of gold nanourchins 710, and some quantity of bromide. In this example, ROS scavengers 140 may be provided as a quaternary ammonium surfactant (e.g., CTAC). Then, if H₂O₂ is generated within droplet 460, some quantity of tribromide is produced within droplet 460. Then, the presence of tribromide within droplet 460 causes the gold nanourchins 710 to be etched, producing both etched gold nanourchins 712, which replace gold nanourchins 710, and gold-bromide complex.

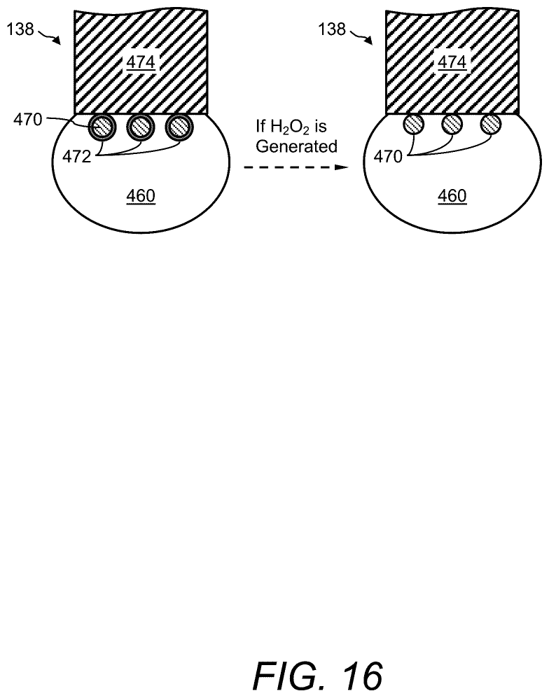

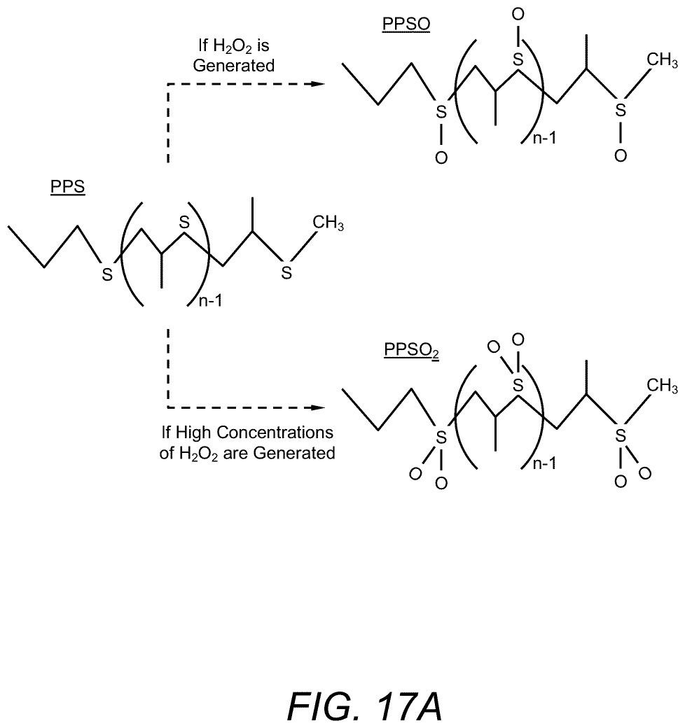

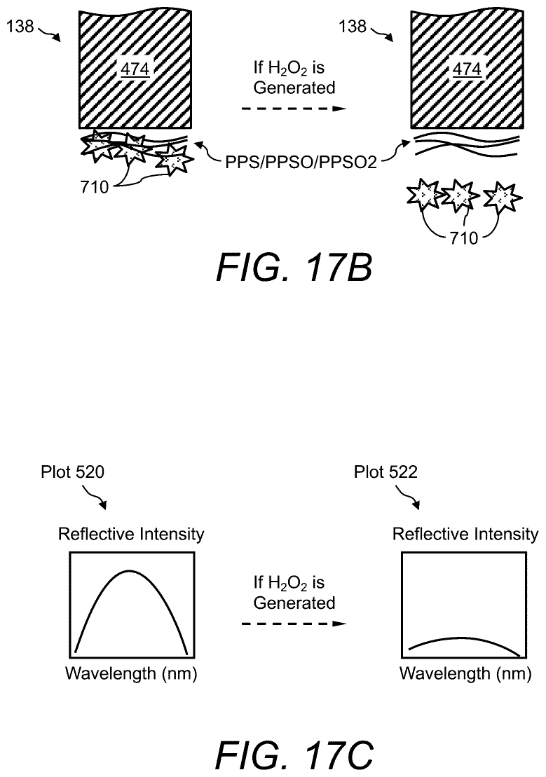

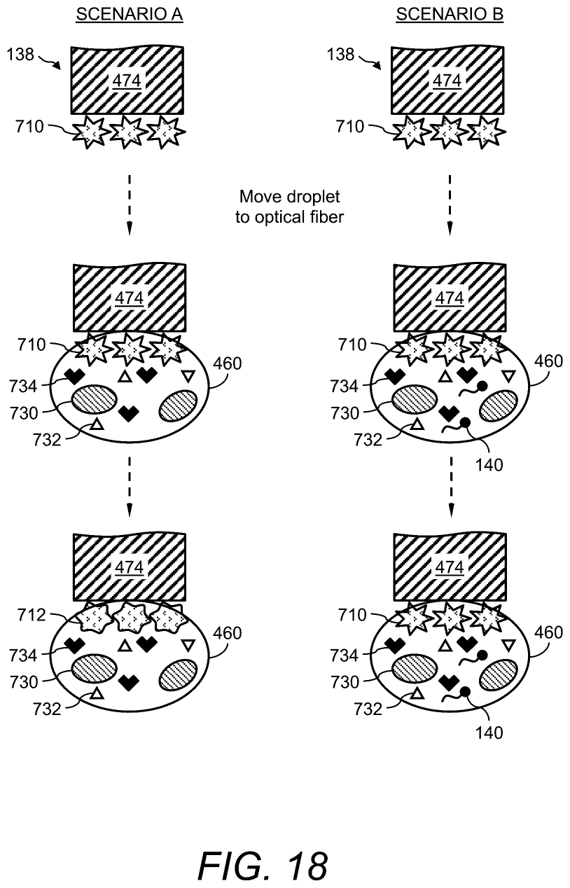

Referring now to FIG. 16 through FIG. 17C are schematic diagrams of examples of mechanisms for detecting ROS in a DMF device, such as DMF device 110 of DMF system 100 shown in FIG. 1. For example, FIG. 16 shows an example of detecting ROS using plasmonic nanoparticles immobilized on an optical fiber. For example, the silver-coated gold nanoparticles shown in FIG. 14 (e.g., gold nanoparticles 470 with silver coatings 472) are immobilized on an optical fiber 474, which is an example of LSPR sensor 138 of DMF device 110 of DMF system 100. In one example, optical fiber 474 may be connected optically to an illumination source 118 and an optical measurement device 120, for example, an optical detector such as a spectrophotometer.

This configuration of LSPR sensor 138 provides an example of using colloidal plasmonic nanoparticles (e.g., the silver-coated gold nanoparticles) to detect ROS. For example, if H₂O₂ is generated within droplet 460, the silver coatings 472 may be etched away from the gold nanoparticles 470. Leaving behind the uncoated gold nanoparticles 470 only within droplet 460. Again, silver coating 472 may be considered a sacrificial layer.

In this example, a sacrificial ROS scavenger also serves as an adhesive for plasmonic nanoparticles to optical fiber 474 (e.g., poly (propylene sulfide)) which can be oxidized to poly (propylene sulfoxide) by H₂O₂. Oxidation of the sacrificial layer results in detachment of the plasmonic nanoparticle (e.g., uncoated gold nanoparticles 470) from optical fiber 474 that may be measured as a decrease in the LSPR peak intensity using the spectrophotometer, as shown below in FIG. 17A, FIG. 17B, and FIG. 17C.

For example, FIG. 17A, FIG. 17B, FIG. 17C show a process of detecting ROS using plasmonic nanoparticles attached to an optical fiber by an adhesive that is responsive to H₂O₂. That is, FIG. 17A shows the oxidation of poly (propylene sulfide) (PPS) to poly (propylene sulfoxide) (PPSO) and to poly (propylene sulfone) (PPSO₂). FIG. 17B shows optical fiber 474 coated with PPS that is used to immobilize gold nanourchins 710 (i.e., gold nanoparticles) on the surface of optical fiber 474. Then, FIG. 17B shows the detachment of gold nanourchins 710 from optical fiber 474 due to oxidation of PPS to PPSO and/or PPSO₂. Next, FIG. 17C shows a plot 720 and a plot 722 indicating an example of the change in reflectance intensity measured by optical fiber 474 due to detachment of gold nanourchins 710 (i.e., gold nanoparticles) after PPS oxidation in FIG. 12.

### Plasmonic Nanoparticle Based Assay to Detect and Characterize ROS

Referring now to FIG. 18 is a schematic diagram of an example of a method to determine whether ROS is generated through the introduction of target analyte and/or to determine whether the ROS scavenger is effective at inhibiting oxidation by ROS. For example, FIG. 18 shows an example in which a plasmonic nanoparticle-based assay can be used to detect the presence of ROS.

In this example, gold nanourchins 710 are immobilized on optical fiber 474 and forming an LSPR sensor 138. Again, optical fiber 474 may be connected optically to an illumination source 118 and an optical measurement device 120, for example, an optical detector such as a spectrophotometer. The illumination source 118 and optical measurement device 120 (e.g., spectrophotometer) may be used to track the change in the LSPR properties of the gold nanourchins 710.

Then, aqueous droplets 460 containing one or more biological cells 730, etching enhancers 732 (for gold nanourchin etching), the analyte 734 being screened, and ROS scavengers 140 are then flowed over the LSPR sensor 138.

In a SCENARIO A, a droplet 460 without ROS scavengers 140, if ROS are generated, the gold nanourchins 710 may be etched and resulting in etched gold nanourchins 712 on the LSPR sensor 138. This results in a shift in the LSPR properties of the gold on the LSPR sensor 138, which can be quantified by the optical detector. That is, in SCENARIO A the gold nanourchins 710 on the LSPR sensor 138 are etched by ROS.

By contrast, in a SCENARIO B, in a droplet 460 containing ROS scavengers 140, ROS are not generated and the gold nanourchins 710 are not etched. This results in substantially no change in the LSPR properties of the gold nanourchins 710 on the LSPR sensor 138, which can be quantified by the optical detector. That is, in SCENARIO B the gold nanourchins 710 on the LSPR sensor 138 are protected by ROS scavengers 140.

The amount of gold nanourchin etching and subsequent LSPR change is dependent on the concentration and type of ROS generated, and the concentration and type of ROS scavengers 140 that are present.

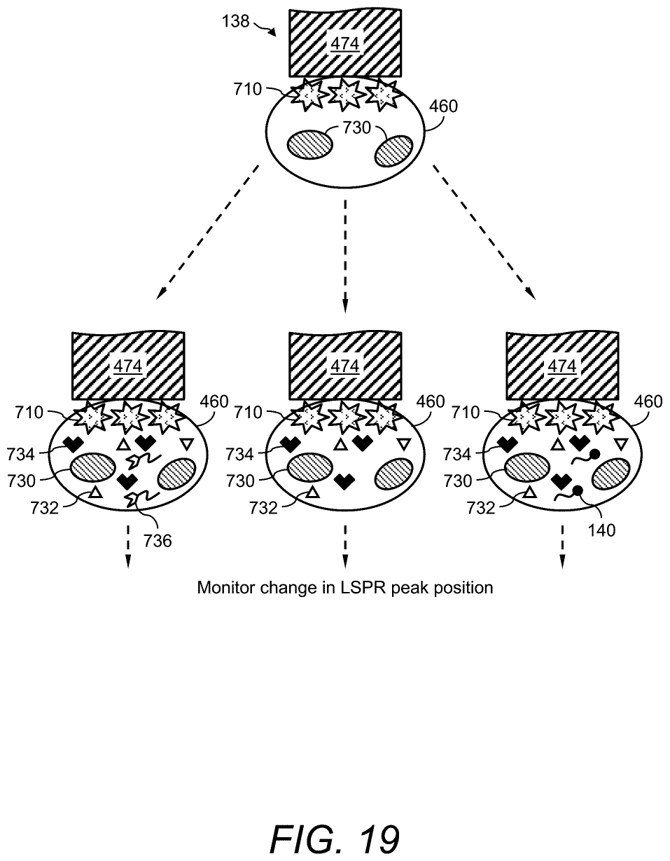

Referring now to FIG. 19 is a schematic diagram of an example of a method to determine whether analyte triggers generation of hydroxyl radicals or hydrogen peroxide. For example, FIG. 19 shows an example in which a plasmonic nanoparticle-based assay can be used to detect and characterize the type of ROS. By building a concentration-dependent standard curve for each potential ROS, the total amount of ROS generated may be quantified based on the LSPR peak shift.

In this example, aqueous droplets 460 containing one or more biological cells 730 are then flowed over the LSPR sensor 138 (e.g., gold nanourchins 710 immobilized on optical fiber 474). Then, one droplet 460 may be mixed with etching enhancers 732 (for gold nanourchin etching), the analyte 734 being screened, and hydroxyl radical scavengers 736. This droplet is absent ROS scavengers 140. Then, another droplet 460 may be mixed with etching enhancers 732 (for gold nanourchin etching) and the analyte 734 being screened. This droplet is absent ROS scavengers 140 and hydroxyl radical scavengers 736. Then, another droplet 460 may be mixed with etching enhancers 732 (for gold nanourchin etching), the analyte 734 being screened, and ROS scavengers 140. This droplet is absent hydroxyl radical scavengers 736. In this example, the change in LSPR peak position is monitored in each of the three droplets 460 to determine whether analyte triggers generation of hydroxyl radicals or hydrogen peroxide.

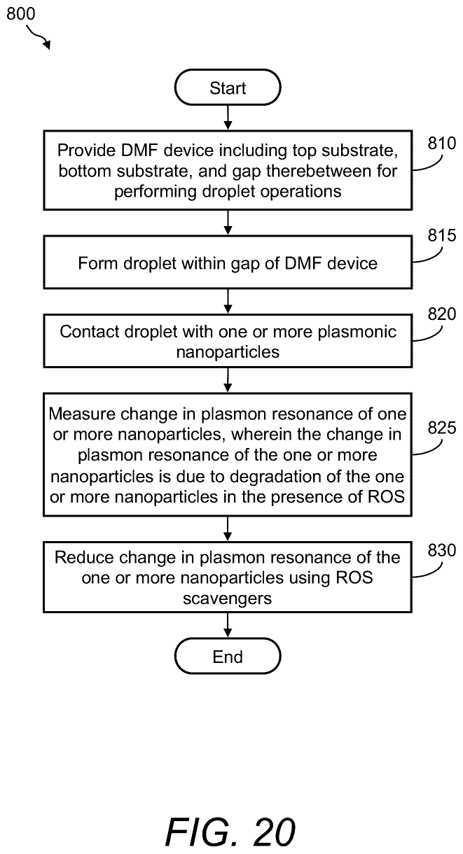

Referring now to FIG. 20 is a flow diagram of an example of a method 800 of detecting ROS in a DMF device, in accordance with an embodiment of the disclosure. For example, method 800 may be used to detect ROS in DMF device 110 of DMF system 100 shown in FIG. 1. Method 800 may include, but is not limited to, the following steps.

At step 810, a DMF device is provided including a top substrate, a bottom substrate, and a droplet operations gap therebetween for performing droplet operations. For example, DMF device 110 shown in FIG. 1 may be provided and wherein DMF device 110 may be formed according to DMF structure 400 shown and described in FIG. 5A and FIG. 5B. That is, DMF structure 400 including top substrate 412, bottom substrate 410, and droplet operations gap 414 therebetween for performing droplet operations.

At a step 815, a droplet is formed within the droplet operations gap of the DMF device. For example, FIG. 18 shows droplets 460 containing one or more biological cells 730, etching enhancers 732 (for gold nanourchin etching), the analyte 734 being screened, and ROS scavengers 140.

At a step 820, the droplet is contacted with one or more plasmonic nanoparticles. For example, FIG. 18 shows droplets 460 containing one or more biological cells 730, etching enhancers 732 (for gold nanourchin etching), the analyte 734 being screened, and ROS scavengers 140 in contact with a LSPR sensor 138 (e.g., gold nanourchins 710 immobilized on optical fiber 474).

At step 825, a change in plasmon resonance of one or more nanoparticles is measured, wherein the change in plasmon resonance of the one or more nanoparticles is due to degradation of the one or more nanoparticles in the presence of ROS. For example, FIG. 18 shows two droplets 460, one without ROS scavengers 140 and one with ROS scavengers 140.

In the droplet 460 without ROS scavengers 140, if ROS are generated, the gold nanourchins 710 may be etched, resulting in a shift in the LSPR properties of the gold, which can be quantified by the optical detector. That is, in this scenario the gold nanourchins 710 are etched by ROS.

By contrast, in the droplet 460 containing ROS scavengers 140, ROS are not generated and the gold nanourchins 710 are not etched, resulting in substantially no change in the LSPR properties of the gold nanourchins 710, which can be quantified by the optical detector. That is, in this scenario the gold nanourchins 710 are protected by ROS scavengers 140.

At step 830, the change in plasmon resonance of the one or more nanoparticles using ROS scavengers is reduced. For example, FIG. 18 shows that in the droplet 460 containing ROS scavengers 140, ROS are not generated and the gold nanourchins 710 are not etched, resulting in substantially no change in the LSPR properties of the gold nanourchins 710, which can be quantified by the optical detector.

### EXAMPLES

### Preliminary Data

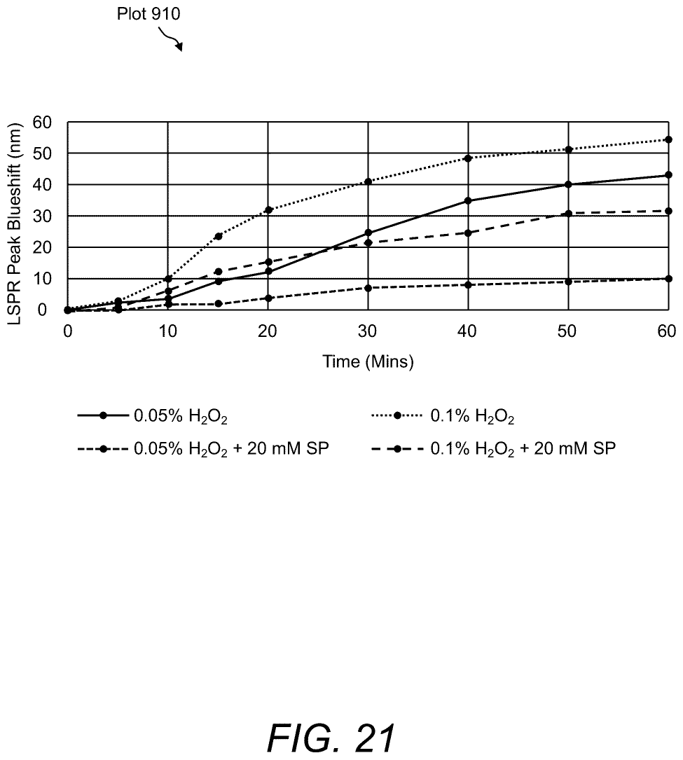

FIG. 21 through FIG. 24 illustrate the change in the LSPR peak position of gold nanourchins after being etched by 0.05, 0.1 and 0.2% H₂O₂ in varying concentrations of sodium bromide (an etching enhancer) and sodium pyruvate (an H₂O₂ scavenger). The results reveal that the rate of change in the gold nanourchins' LSPR peak over time is directly proportional to the concentration of H₂O₂ and sodium bromide. FIG. 21 through FIG. 24 also reveal that the addition of 20 mM sodium pyruvate slows down the rate of etching (and change in LSPR peak) at 0.05% and 0.1% H₂O₂.

In this experiment, 90 nm gold nanourchins (of optical density 4.9) coated with CTAC and suspended in deionized water were pipetted into a 96-well microplate. Varying concentrations of NaBr and sodium pyruvate were then added to the wells containing gold nanourchins. The UV-Vis spectra of the gold nanourchins was measured, and the LSPR peak position (i.e., lambda max) was recorded. This measurement was considered the initial (or time=0) LSPR peak. Varying concentrations of H₂O₂ were then added to the gold nanourchin mixtures and the LSPR peak position was monitored over 60 minutes.

Referring now to FIG. 21 is an example of a plot 910 showing the change in gold nanourchins LSPR peak over time in varying concentrations of H₂O₂ and sodium pyruvate. In plot 910, SP means sodium pyruvate (i.e., H₂O₂ scavenger). Plot 910 shows a plot of LSPR Peak Blueshift vs Time for 0.05% H₂O₂, 0.1% H₂O₂, 0.05% H₂O₂+20 mM SP, and 0.1% H₂O₂+20 mM SP. Further, the concentration of NaBr was 20 mM in all samples.

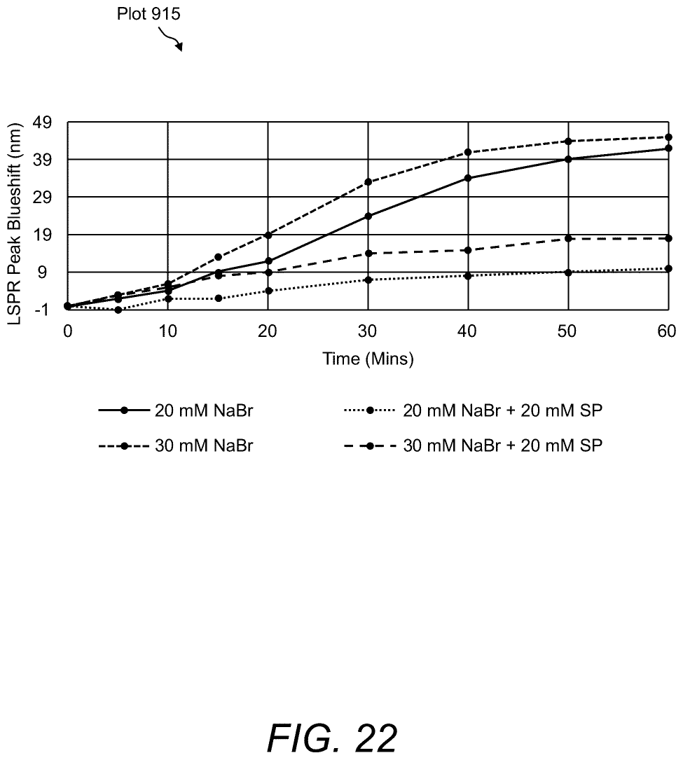

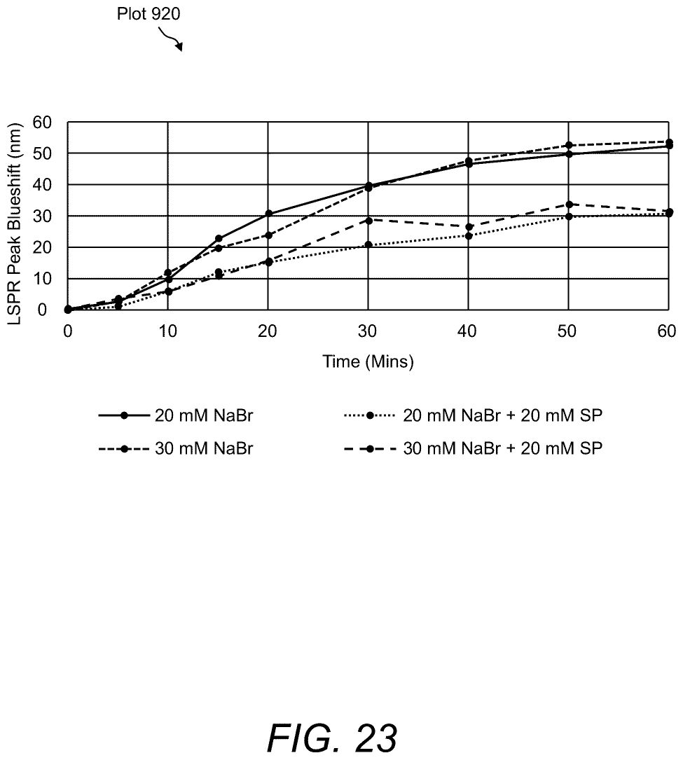

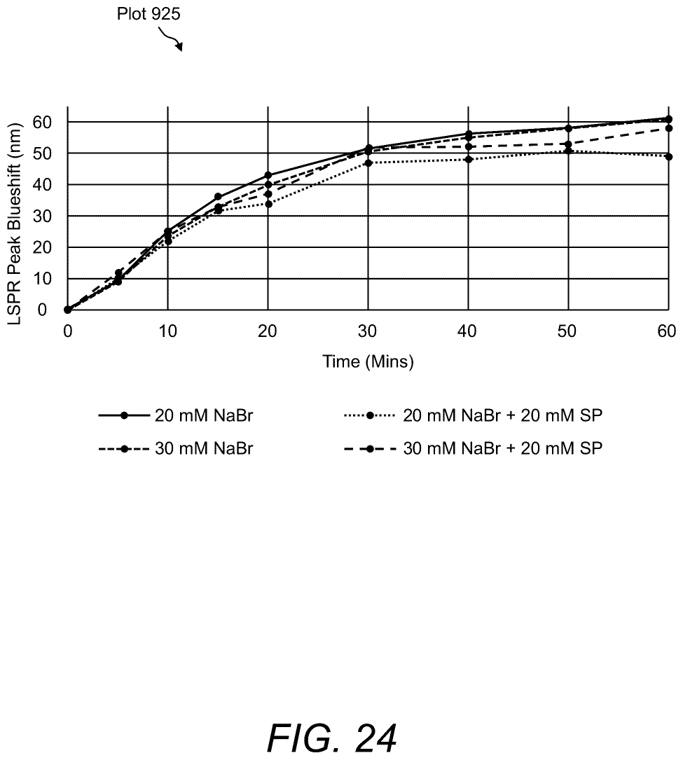

Referring now to FIG. 22, FIG. 23, and FIG. 24 are examples of plots showing the change in gold nanourchins LSPR peak over time in varying concentrations of H₂O₂, sodium bromide, and sodium pyruvate, respectively. For example, FIG. 22 shows a plot 915, FIG. 23 shows a plot 920, and FIG. 24 shows a plot 925.

Plots 915, 920, 925 show plots of LSPR Peak Blueshift vs Time in varying concentrations by weight per volume % of H₂O₂. Plot 915 shows a plot of LSPR Peak Blueshift vs Time for 0.05% H₂O₂. Plot 920 shows a plot of LSPR Peak Blueshift vs Time for 0.1% H₂O₂. Plot 925 shows a plot of LSPR Peak Blueshift vs Time for 0.2% H₂O₂. In plots 915, 920, 925, SP means sodium pyruvate (i.e., H₂O₂ scavenger) and NaBr means sodium bromide (i.e., enhancer).

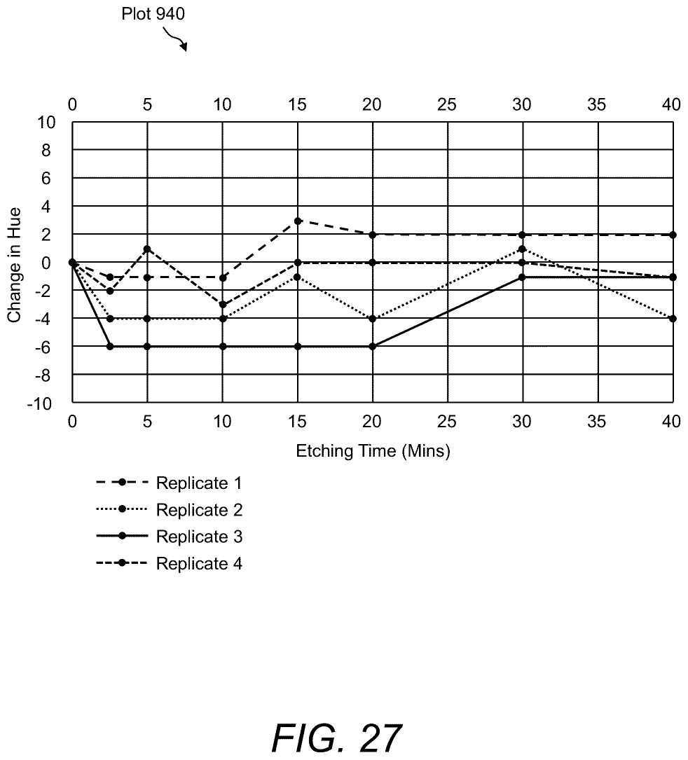

Further, plots 915, 920, 925 show an example of using gold nanourchins to detect generation of reactive oxidative species on a DMF cartridge. The image below was taken 30 minutes after an aqueous suspension of gold nanourchins coated with CTAC was mixed with NaBr on cartridge. Across the three replicates of gold nanourchins+NaBr mixtures, the initial color was blue, and the hue values were between ˜220-235. After 30 minutes, 2 of the gold nanourchin replicates etched and changed color from blue to purple (with the hue value rising to 280). This change in color is due to etching of the gold nanourchins by ROS unintentionally generated on the DMF cartridge. This is proved by the stability of gold nanourchin+NaBr mixtures that contain sodium pyruvate (an H₂O₂ scavenger), as seen in FIG. 27 through FIG. 30. Gold nanourchins+NaBr+sodium pyruvate mixtures showed minimal change in hue value across 4 cartridges (containing multiple replicates per cartridge).

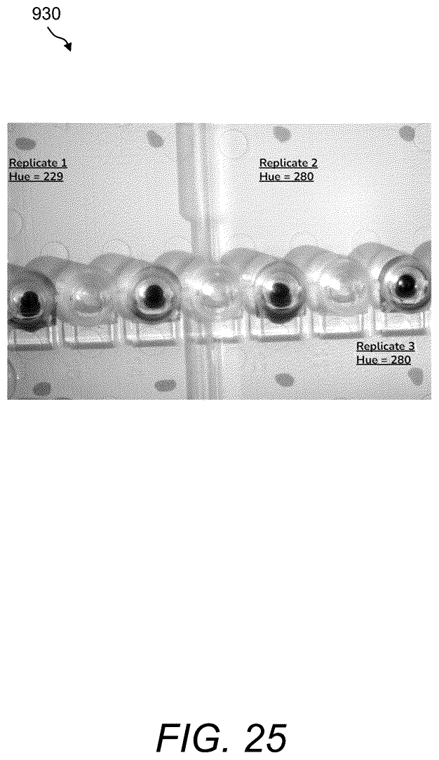

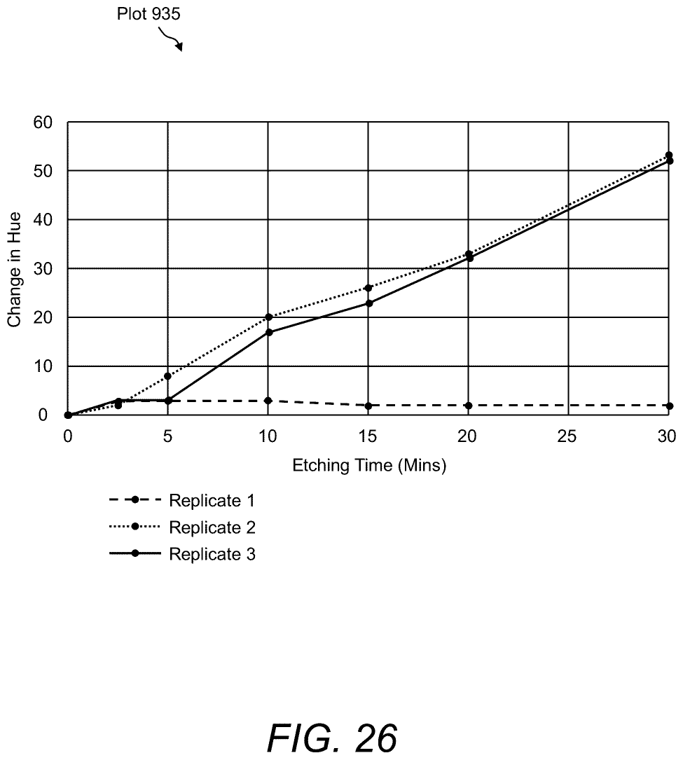

Referring now to FIG. 25 and FIG. 26 is a photo 930 and a plot 935, respectively, of an example of the detection of unwanted generation of ROS on a DMF device using plasmonic nanoparticles. Photo 930 shows 30 minutes after mixing gold nanourchins+NaBr droplets on a DMF cartridge. Plot 935 shows a change in hue value of gold nanourchin+NaBr droplets on a DMF cartridge.

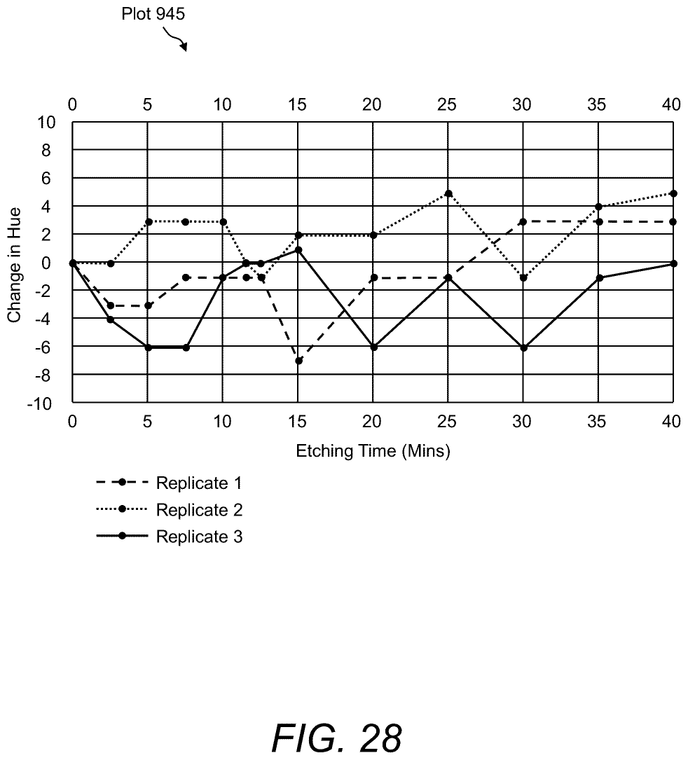

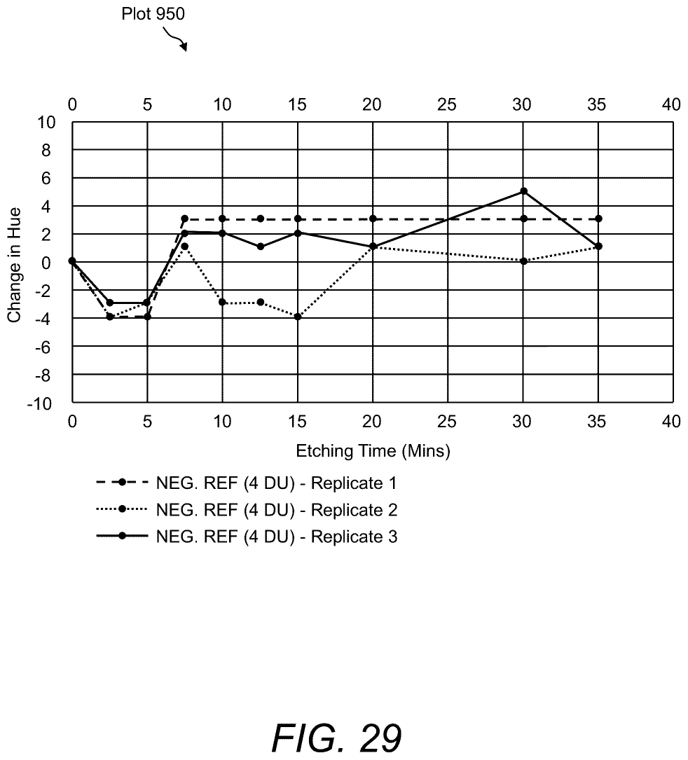

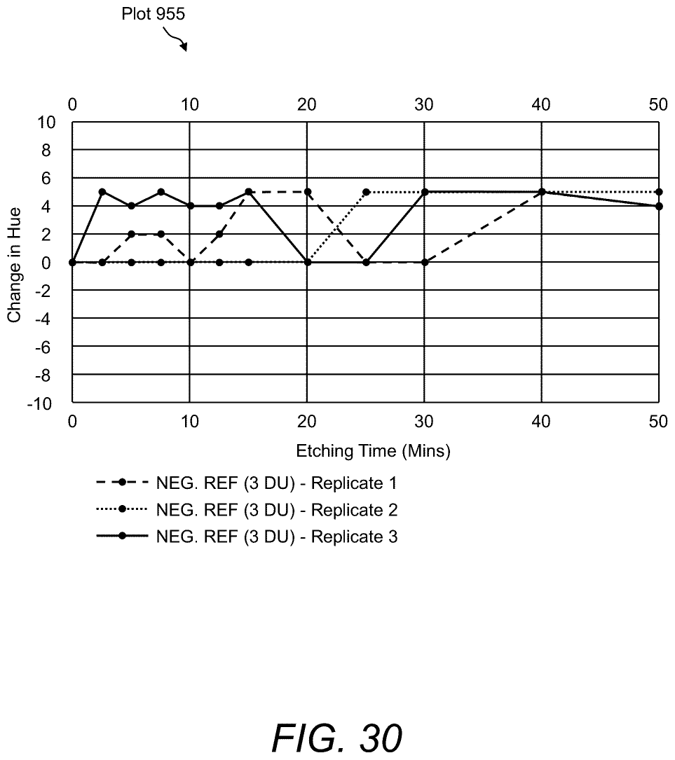

Referring now to FIG. 27 through FIG. 30 are plots of examples of the change in hue value of gold nanourchins+NaBr mixtures with sodium pyruvate addition. A plot 940 shown in FIG. 27 corresponds to a DMF cartridge #1. A plot 945 shown in FIG. 28 corresponds to a DMF cartridge #2. A plot 950 shown in FIG. 29 corresponds to a DMF cartridge #3. A plot 955 shown in FIG. 30 corresponds to a DMF cartridge #4.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the invention shall also cover any such alternatives, modifications, variations or equivalents. It is intended that the following claims define the scope of the disclosure and that methods and structures within the scope of these claims and their equivalents be covered thereby.

1. A method for reducing reactive oxygen species (“ROS”) in a digital microfluidic (“DMF”) device, the method comprising the steps of:
providing a DMF device comprising a top substrate, a bottom substrate, and a gap therebetween for performing droplet operations;
forming a droplet within the gap of the DMF device; and
contacting the droplet with a ROS scavenger disposed within the gap of the DMF device.

2. The method of claim 1, wherein the ROS scavenger is one or more different ROS scavengers.

3. The method of claim 1, wherein the ROS scavenger is selected from the group consisting of: superoxide dismutase, catalase, glutathione peroxidase, sodium pyruvate, mannitol, ascorbic acid, glutathione, phenol, polyphenol, thiols, CeO₂, MnO₂, hexyl maltoside, polyglycerol surfactants, alpha-tocopherol, cellulose nanocrystals and other polysaccharide pickering emulsifiers, or combinations thereof.

4. The method of claim 1, wherein the ROS scavenger is selected from: superoxide dismutase, sodium pyruvate, mannitol, CeO₂, MnO₂, hexyl maltoside, alpha-tocopherol or combinations thereof.

5. The method of claim 1, wherein the ROS scavenger is disposed on at least a portion of a surface of the DMF device.

6. The method of claim 5, wherein contacting the droplet with the ROS scavenger comprises contacting the droplet with the portion of the surface of the DMF device having the ROS scavenger disposed thereon.

7. The method of claim 5, wherein the surface is a sensor surface.

8. The method of claim 7, wherein the sensor surface is a surface plasmon resonance (SPR) or localized surface plasmon resonance (LSPR) sensor surface.

9. The method of claim 8, wherein the SPR or LSPR sensor surface comprises a metal selected from the group consisting of: Gold, Silver, Copper, or combinations thereof.

10. The method of claim 5, wherein the surface is a surface of the top or bottom substrate.

11. The method of claim 5, wherein the surface is a surface of one or more beads.

12. The method of claim 11, wherein the one or more beads are one or more magnetic beads.

13. The method of claim 1, wherein the ROS scavenger is disposed within a filler fluid.

14. The method of claim 13, wherein contacting the droplet with the ROS scavenger comprises contacting the droplet with the filler fluid such that the ROS scavenger diffuses to an interface between the droplet and the filler fluid.

15. The method of claim 13, wherein the ROS scavenger is a surfactant.

16. The method of claim 13, wherein the filler fluid is an oil.

17. The method of claim 16, wherein the oil is a silicone oil, perfluorinated oil, hydrocarbon-based oil or a combination thereof.

18. The method of claim 1, wherein the ROS scavenger is disposed within a second droplet.

19. The method of claim 18, wherein contacting the droplet with the ROS scavenger comprises merging the droplet with the second droplet.

20. The method of claim 1, wherein the fluid droplet comprises one or more of a reagent, sample, or analyte.

21. The method of claim 20, wherein the ROS scavenger prevents degradation of one or more of the reagent, sample, or analyte.

22.-47. (canceled)
